(19) United States
(12) Patent Application Publication
(10) Pub. No.: US 2003/0074606 A1
(43) Pub. Date: Apr. 17, 2003

(54) Network-based control center for conducting performance tests of server systems

(76) Inventor: Udi Boker, Hod-Hasharon (IL)

Correspondence Address: KNOBBE MARTENS OLSON & BEAR LLP, 2040 MAIN STREET, FOURTEENTH FLOOR, IRVINE, CA, 92614, US

(21) Appl. No.: 10/011,343

(22) Filed: Nov. 16, 2001

Related U.S. Application Data
(60) Provisional application No. 60/318,939, filed on Sep. 10, 2001.

(51) Int. Cl. H04L 1/22

(52) U.S. Cl. 714/42

(57) ABSTRACT

A network-based load testing system provides various functions for managing and conducting load tests remotely using a web browser. The system supports the ability to have multiple, concurrent load testing projects that share processing resources. In one embodiment, the system includes host computers (“hosts”) that reside in one or more geographic locations. Through an administration web site, administrators allocate specific hosts to specific load testing “projects,” and specify how each such host may be used (e.g., as a “load generator” or an “analyzer”). An administrator may also assign users to specific projects, and otherwise control the access rights of each user of the system. Through a user web site, testers reserve hosts within their respective projects for conducting load tests, and create, run, and analyze the results of such load tests. Each project's data (scripts, load tests, test results, etc.) is maintained private to members of that project. Attempts to load test unauthorized targets are automatically blocked.

### PRIORITY CLAIM

This application claims the benefit of U.S. Provisional Appl. No. 60/318,939, filed Sep. 10, 2001 and titled SYSTEM FOR REMOTELY CONTROLLING AND MANAGING TESTS OF MULTI-USER SYSTEMS, the disclosure of which is hereby incorporated by reference.

### FIELD OF THE INVENTION

The present invention relates to systems and methods for testing web-based and other multi-user systems. More specifically, the invention relates to systems and methods for conducting load tests and other types of server performance tests over a wide area network such as the Internet.

### BACKGROUND OF THE INVENTION

Prior to deploying a mission-critical web site or other multi-user system on a wide-scale basis, it is common to conduct load testing to evaluate how the system will respond under heavy user load conditions. A load test generally involves simulating the actions of relatively large numbers of users while monitoring server response times and/or other performance metrics. Typically, this involves generating scripts that specify sequences of user requests or messages to be sent to the target system. The scripts may also specify expected responses to such requests.

During running of a load test, one or more of these scripts are run—typically on host computers that are locally connected to the target system—to apply a controlled load to the target system. As the load is applied, data is recorded regarding the resulting server and transaction response times and any detected error events. This data may thereafter be analyzed using off-line analysis tools. Performance problems and bottlenecks discovered through the load testing process may be corrected by programmers and system administrators prior to wide-scale deployment of the system.

The task of load testing a target system typically involves installing special load testing software on a set of host computers at the location of the target system. The load tests are then generated and run on-site by testers who are skilled in script writing and other aspects of load testing. One problem with this approach is that the cost of setting up dedicated load testing hosts at the site of the target system tends to be high. Another problem is that the cost of training on-site employees how to use the load testing software, and/or of bringing outside load testing consultants to the testing site, tends to be high. Yet another problem, particularly when a company wishes to deploy a new web site or application on short notice, is that the time needed to obtain adequate human and computing resources for locally conducting load testing is often prohibitive.

A further problem is that existing load testing systems generally do not support the ability to conduct multiple concurrent load tests using shared resources. As a results, load tests generally must be run either serially or using duplicated testing resources. Yet another problem is that existing systems do not provide an efficient and effective mechanism for allowing testers in different geographic locations to share test data and test results, and to collaborate in the testing process.

The foregoing problems are also pertinent—although generally to a lesser extent—to functionality testing, security testing, and post-deployment performance monitoring of multi-users systems.

### SUMMARY OF THE INVENTION

The present invention addresses the above and other problems with conventional systems and methods for testing multi-user server systems. In accordance with the invention, a network-based system is provided that allows users to manage and conduct tests of multi-user systems remotely—preferably using an ordinary web browser. The system supports the ability to have multiple, concurrent testing projects that share processing resources. The tests may be created and run by users that are distributed across geographic regions, without the need to physically access the host computers from which the tests are run. The system is preferably adapted specifically for conducting load tests, but may additionally or alternatively be adapted for functionality testing, security testing, post-deployment performance monitoring (e.g., of web sites), and other types of testing applications.

In one embodiment specifically adapted for load testing, the system includes host computers (“hosts”) that reside in one or more geographic locations. Through an administration web site of the system, administrators allocate specific hosts to specific load testing “projects,” and preferably specify how each such host may be used (e.g., as a “load generator” or an “analyzer”). An administrator may also specify host priority levels, or other criteria, that indicate how the hosts are to be dynamically allocated to test runs. Using a privilege manager component, an administrator may also assign users to specific projects, and otherwise control the access rights of individual users of the system.

Through a user web site of the system, testers reserve hosts (or other units of processing capacity) within their respective projects for conducting load tests—preferably for specific timeslots. The user site also provides functionality for testers to create, run, and analyze the results of such load tests, and to collaborate with other members of the same project. Preferably, attempts to load test target systems other than those authorized for the particular project or other user group are automatically blocked, so that system resources are not used for malicious purposes such as denial-of-service attacks. Each project's data (scripts, load tests, test results, etc.) may be accessed by members of that project, and is preferably maintained private to such members.

The load testing system may, for example, be set up and managed by a particular company, such as an e-commerce or software development company, for purposes of conducting pre-deployment load tests of that company's web sites, web applications, internal systems, or other multi-user systems. The system may alternatively be operated by a load testing service provider that provides hosted load testing services to customers.

One embodiment of the load testing system provides numerous advantageous over previous load testing systems and methods. These benefits include the efficient sharing of test data and test results across multiple locations, more efficient use of processing resources (e.g., because multiple groups of users can efficiently share the same hosts without being exposed to each other's confidential information), increased ability to use remote testing consultants/experts and reduced travel expenses for such use; and improved efficiency in managing and completing testing projects.

### BRIEF DESCRIPTION OF THE DRAWINGS

The above and other features and benefits will now be described with reference to certain illustrative embodiments of the invention, which are depicted in the following drawings:

FIG. 1 illustrates a load testing system and associated components according to one embodiment of the invention.

FIG. 2 illustrates a Home page of the User site of FIG. 1.

FIG. 3 illustrates a Timeslots page of the User site.

FIG. 4 illustrates a Vuser Scripts page of the User site.

FIG. 5A illustrates a Load Test Configuration page of the User site.

FIG. 5B illustrates a window for specifying Vuser runtime settings.

FIG. 6 illustrates a Load Tests page of the User site.

FIG. 7 illustrates a Load Test Run page of the User site.

FIG. 8A illustrates a Load Test Results page of the User site.

FIG. 8B illustrates an interactive analysis page of the User site.

FIG. 9 illustrates a Host page of the Administration site of FIG. 1.

FIG. 10 illustrates an Add New Host page of the Administration site.

FIG. 11 illustrates a Pools page of the Administration site.

FIG. 12 illustrates a Host Administration page of the Administration site.

FIG. 13 illustrates one view of a Timeslots page of the Administration site.

FIG. 14 illustrates another view of the Timeslots page of the Administration site.

FIG. 15 illustrates a Test Runs page of the Administration site.

FIG. 16 illustrates an Errors page of the Administration site.

FIG. 17 illustrates a General Settings page of the Administration site.

FIG. 18 illustrates a Personal Information page of the Privilege Manager of FIG. 1.

FIG. 19 illustrates a Users page of the Privilege Manager.

FIG. 20 illustrates a process by which a user's project access list may be specified using the Privilege Manager.

FIG. 21 illustrates a Projects page of the Privilege Manager.

FIG. 22 illustrates a process by which the access list for a project may be specified using the Privilege Manager.

FIG. 23 illustrates a process by which load testing may be restricted to certain target addresses using the Privilege Manager.

FIG. 24 illustrates a User Privilege Configuration page of the Privilege Manager.

FIG. 25 illustrates additional architectural details of the system shown in FIG. 1 according to one embodiment of the invention.

FIG. 26 illustrates an example database design used for timeslot reservations.

FIG. 27 illustrates an embodiment in which a tester can reserve hosts in specific locations for specific purposes.

FIG. 28 illustrates a feature that allows components of the system under test to be monitored over a firewall during load testing.

FIGS. 29 and 30 are example screen displays of the server monitoring agent component shown in FIG. 28.

### DETAILED DESCRIPTION OF ILLUSTRATIVE EMBODIMENTS

The following description is intended to illustrate certain embodiments of the invention, and not to limit the invention. The system described in this detailed description section embodies various inventive features that may be used individually or in combination to facilitate testing of networked devices and server systems. Some of these features may be practiced or implemented without others. In addition, many of the features may be implemented or used differently than in the embodiments set forth herein. For instance, although described primarily in the context of a load testing, it will be recognized that many of the inventive features are also applicable to functionality testing and to post-deployment monitoring. The invention is defined by the appended claims.

The detailed description of the illustrative embodiments is arranged within the following sections and subsections:

I. Overview

II. Typical Usage Scenario

III. User Web Site

A. Navigation Menu

B. Home and Project Selection Pages

C. Timeslots Page

D. Vuser Scripts Page

E. Load Test Configuration Page

F. Load Tests Page

G. Load Test Run Page

H. Load Test Results Page

IV. Administration Web Site

A. Navigation Menu

B. Host and Pool Management Pages

C. Timeslot Reservation Pages

D. Test Runs page

E. Errors Page

F. General Settings Page

V. Privilege Manager

A. Navigation Menu and Privilege Levels

B. Personal Information Page

C. Users Page

D. Projects Page

E. User Privilege Configuration Page

VI. System Architecture

VII. Timeslot Reservations and Allocations of Hosts

A. Timeslot Reservation Algorithm

B. Host Allocation Algorithm

C. Designation of Controller Hosts

D. Reserving Machines in Specific Locations

VIII. Resource Sharing and Negotiation Between Installations

IX. Protection Against Potentially Harmful Scripts

X. Server Monitoring over Firewall

XI. Hosted Service Implementations

XII. Conclusion

I. Overview

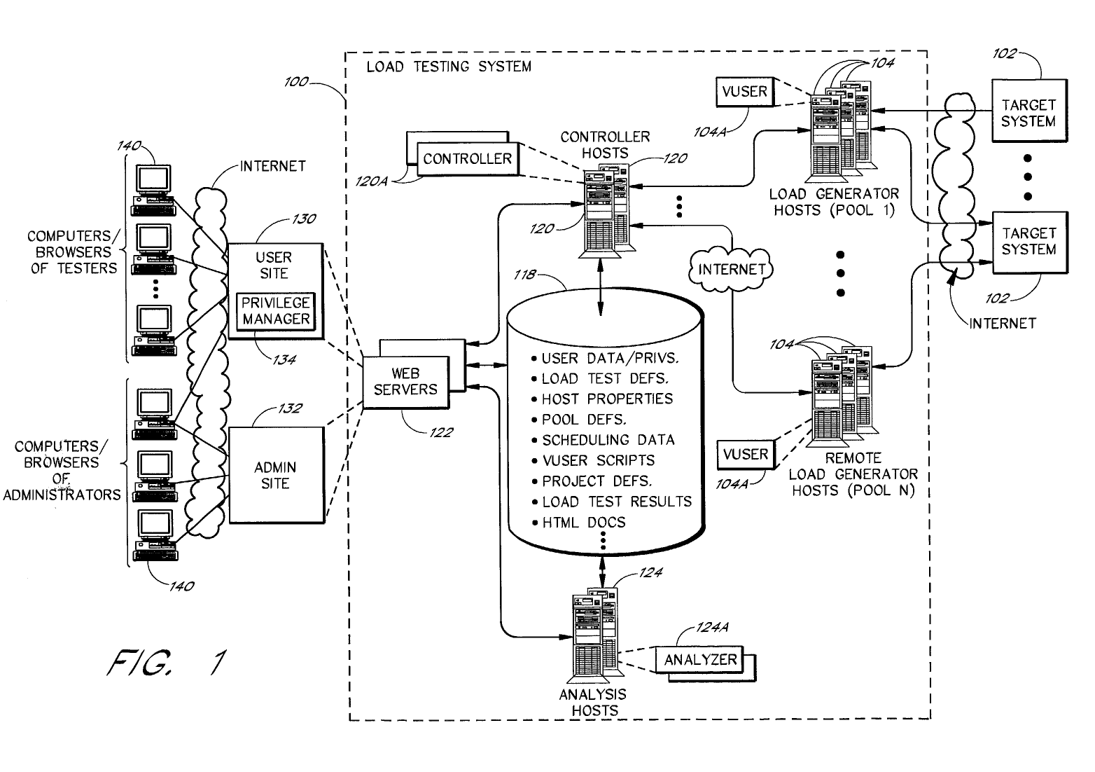

FIG. 1 illustrates the general architecture of a load testing system 100 according to one embodiment of the invention. The load testing system 100 provides various functions and services for the load testing of target systems 102, over the Internet or another network connection. Each target system 102 may be a web site, a web-based application, or another type of multi-user system or component that is accessible over a computer network. For purposes of illustration, the load testing system 100 will be described primarily in the context of the testing of web sites and web-based applications, although the description is also applicable to the various other types of multi-user systems that may be load tested.

The various components of the system 100 form a distributed, web-based load testing application that enables users to create, run and analyze load tests remotely and interactively using a web browser. The load testing application includes functionality for subdividing and allocating host processing resources among users and load tests such that multiple users can run their respective load tests concurrently. The application also provides various services for users working on a common load testing project to collaborate with each other and to share project data.

The load testing system 100 may be operated by a company, such as an e-commerce or software development company, that has one or more web sites or other target systems 102 it wishes to load test. For instance, in one embodiment, the various software components of the load testing system 100 can be installed on the company's existing corporate infrastructure (host computers, LAN, etc.) and thereafter used to manage and run load testing projects. Some or all components of the system 100 may alternatively be operated by a load testing service provider that provides a hosted load testing service to customers, as described generally in U.S. patent application Ser. No. 09/484,684, filed Jan. 17, 2000 and published as WO 01/53949, the disclosure of which is hereby incorporated by reference.

As described in detail below, the system 100 provides functionality for allowing multiple load testing “projects” to be managed and run concurrently using shared processing resources. Each such project may, for example, involve a different respective target system 102. The system 100 provides controlled access to resources such that a team of users assigned to a particular project to securely access that project's data (scripts, load test definitions, load test results, etc.), while preventing such data from being accessed by others.

As depicted in FIG. 1, the load testing system 100 includes load generator hosts 104 that apply a load to the system(s) under test 102. (The terms “host,” “host computer,” and “machine” are used generally interchangeably herein to refer to a computer system, such as a Windows or Unix based server or workstation.) Some or all of the load generator hosts 104 are typically remote from the relevant target system 102, in which case the load is applied to the target system 102 over the Internet. In addition, some or all of the load generator hosts 104 may be remote from each other and/or from other components of the load testing system 100. For instance, if the load testing system is operated by a business organization having offices in multiple cities or countries, host computers in any number of these offices may be assigned as load generator hosts.

As described below, an important feature of the load testing system 100 is that an administrator can allocate specific hosts to specific load testing projects. Preferably, the administrator may also specify how such hosts may be used (e.g., as a load generator, a test results analyzer, and/or a session controller). For instance, a particular pool of hosts may be allocated to particular project or set of projects; and some or all of the hosts in the pool may be allocated specifically as load generator hosts 104. A related benefit is that the load generator hosts 104, and other testing resources, may be shared across multiple ongoing load testing projects. For instance, a group or pool of load generator hosts may be time shared by a first group of users (testers) responsible for load testing a first target system 102 and a second group of testers responsible for testing a second target system 102. Yet another benefit is that users can reserve hosts for specific time periods in order to run their respective tests. These and other features are described below.

Each load generator host 104 preferably runs a virtual user or “Vuser” component 104A that sends URL requests or other messages to the target system 102, and monitors responses thereto, as is known in the art. The Vuser component of the commercially-available LoadRunner® product of Mercury Interactive Corporation may be used for this purpose. Typically, multiple instances of the Vuser component 104A run concurrently on the same load generator host, and each instance establishes and uses a separate connection to the server or system under test 102. Each such instance is referred to generally as a “Vuser.” The particular activity and communications generated by a Vuser are preferably specified by a Vuser script (also referred to simply as a “script”), which may be uploaded to the load generator hosts 104 as described below.

Each load generator host 104 is typically capable of simulating (producing a load equivalent to that of) several hundred or thousand concurrent users. This may be accomplished by running many hundreds or thousands of Vusers on the load generator host, such that each Vuser generally simulates a single, real user of the target system 102. A lesser number of Vusers may alternatively be used to produce the same load by configuring each Vuser to run its script more rapidly (e.g., by using a small “think time” setting). Processing methods that may be used to create the load of a large number of real users via a small number of Vusers are described in U.S. patent application Ser. No. 09/565,832, filed May 5, 2000, the disclosure of which is hereby incorporated by reference.

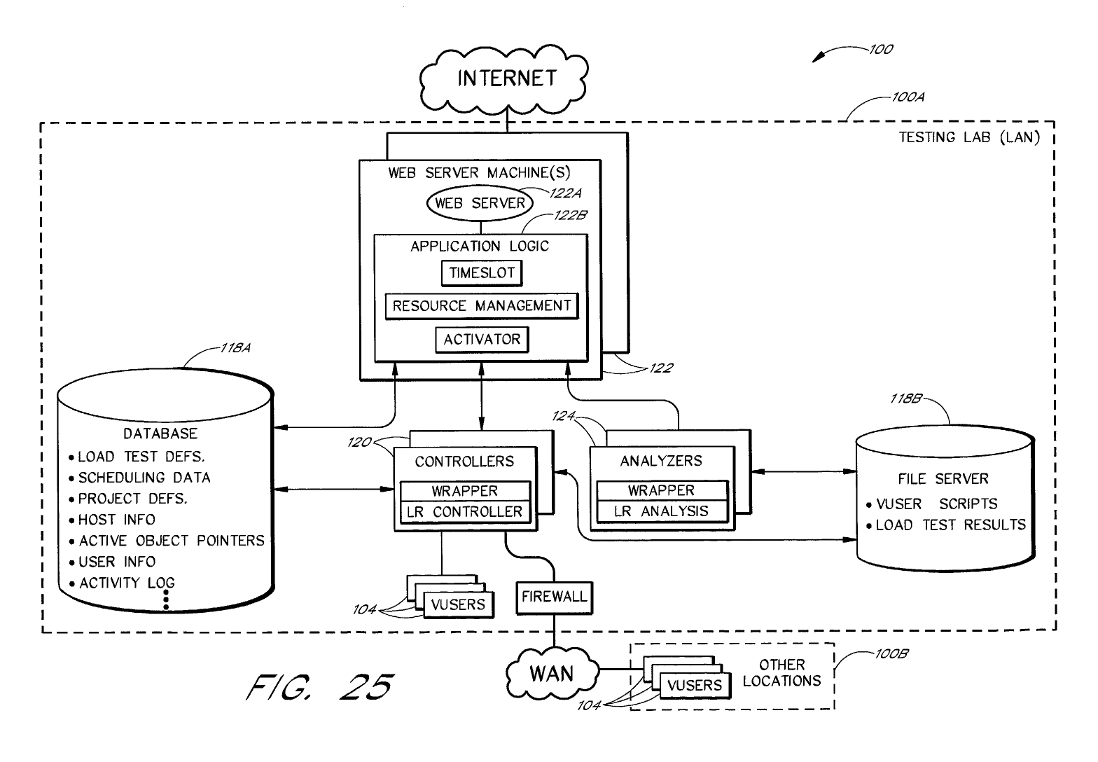

As shown in FIG. 1, the load testing system 100 also preferably includes the following components: a data repository 118, one or more controller host computers (“controller hosts”) 120, one or more web servers 122, and one or more analysis hosts computers (“analysis hosts”) 124. The data repository 118 stores various types of information associated with load testing projects. As illustrated, this information includes personal information and access rights of users, load test definitions created by users, information about the various hosts that may be used for load testing, Vuser scripts that have been created for testing purposes, data produced from test runs, and HTML documents. In one embodiment, the repository 118 includes a file server that stores the Vuser scripts and load test results, and includes a database that stores the various other types of data (see FIG. 25). Some or all of the system's software components are typically installed on separate computers as shown, although any one or more of the components (including the Vuser components 104A) may be installed and executed on the same computer in some embodiments.

The controller hosts 120 are generally responsible for initiating and terminating test sessions, dispatching Vuser scripts and load test parameters to load generator hosts 104, monitoring test runs (load test execution events), and storing the load test results in the repository 118. Each controller host 120 runs a controller component 120A that embodies this and other functionality. The controller component 120A preferably includes the controller component of the LoadRunner® product of Mercury Interactive Corporation, together with associated application code, as described below with reference to FIG. 25. A host machine that runs the controller component 120A is referred to generally as a “controller.”

The analysis hosts 124 are responsible for generating various charts, graphs, and reports of the load test results data stored in the data repository 118. Each analysis host 124 runs an analyzer component 124A, which preferably comprises the analysis component of the LoadRunner® product of Mercury Interactive Corporation together with associated application code (as described below with reference to FIG. 25). A host machine that runs the analyzer component 124A is referred to generally as an “analyzer.”

The web server or servers 122 provide functionality for allowing users (testers, administrators, etc.) to remotely access and control the various components of the load testing system 100 using an ordinary web browser. As illustrated, each web server 122 communicates with the data repository 118, the controller(s) 120 and the analyzer(s) 124, typically over a LAN connection. As discussed below with reference to FIG. 25, each web server machine preferably runs application code for performing various tasks associated with load test scheduling and management.

Although the load generators, controllers, and analyzers are depicted in FIG. 1 as (and preferably are) separate physical machines, a single physical machine may concurrently serve as any two or more of these host types in some implementations. For instance, in one embodiment, a given host computer can concurrently serve as both a controller and a load generator. In addition, as described below, the function performed by a given host computer may change over time, such as from one load test to another. The web server(s) 122 and the data repository 118 are preferably implemented using one or more dedicated servers, but could be implemented in-whole or in-part within a physical machine that serves as a controller, an analyzer and/or a load generator. Various other allocations of functionality to physical machines and code modules are also possible, as will be apparent to those skilled in the art.

As further depicted in FIG. 1, the functionality of the load testing system 100 is preferably made accessible to users via a user web site (“User site”) 130, an administration web site (“Administration site”) 132, and a privilege manager web site (“Privilege Manager”) 134. Using these web sites 130-134, users of the system 100 can create, run and analyze results of load tests, manage concurrent load testing projects, and manage load testing resources—all remotely over the Internet using an ordinary web browser. Although three logically distinct web sites or applications 130-134 are used in the preferred embodiment, a lesser or greater number of web sites or applications may be used. Further, although the use of a web-based interface advantageously allows the load testing process to be controlled using an ordinary web browser, it will be recognized that other types of interfaces and components could be used; for example, some or all types of users could be permitted or required to download a special client component that provides an interface to the load testing system 100.

The User site 130 includes functionality (web pages and associated application logic) for allowing testers to define and save load tests, schedule load test sessions (test runs), collaborate with other users on projects, and view the status and results of such load test runs. The actions that may be performed by a particular user, including the projects that may be accessed, are defined by that user's access privileges. The following is a brief summary of some of the functions that are preferably embodied within the User site 130. Additional details of one implementation of the User site 130 are described in section III below.

Create load tests—Users can generate Vuser scripts using a hosted recorder and/or upload Vuser scripts recorded remotely. In addition, users can define and configure load tests that use such scripts. Scripts and load tests created by one member of a project are accessible to other members of the same project.

Reserve processing resources for test runs—A tester wishing to run a load test can check the availability of hosts, and reserve a desired number of hosts (or possibly other units of processing resources), for specific timeslots. Preferably, timeslot reservations can be made before the relevant load test or tests have been defined within the system 100. Each project may be entitled to reserve hosts from a particular “pool” of hosts that have been assigned or allocated to that project. During test runs, the reserved hosts are preferably dynamically selected for use using a resource allocation algorithm. In some embodiments, a user creating a timeslot reservation is permitted to select specific hosts to be reserved, and/or is permitted to reserve hosts for particular purposes (e.g., load generator or controller).

Run and analyze load tests—Testers can interactively monitor and control test runs in real time within their respective projects. In addition, users can view and interactively analyze the results of prior test runs within their respective projects.

The Administration site 132 provides functionality for managing hosts and host pools, managing timeslot reservations, and supervising load test projects. Access to the Administration site 132 is preferably restricted to users having an “admin” or similar privilege level, as may be assigned using the Privilege Manager 134. The following is a brief summary of some of the functions that are preferably embodied within the Administration site 132. Additional details of one implementation of the Administration site 130 are described in section IV below.

Management of hosts—The Administration site 132 provides various host management functions, including functions for adding hosts to the system 100 (i.e., making them available for load testing), deleting hosts from the system, defining how hosts can be used (e.g., as a load generator versus an analyzer), and detaching hosts from test runs. In addition, an administrator can specify criteria, such as host priority levels and/or availability schedules, that control how the hosts are selected for use within test runs. The Administration site 132 also provides pages for monitoring host utilization and error conditions.

Formation and allocation of pools—Administrators can also define multiple “pools” of hosts, and assign or allocate each such pool to a particular project or group of projects. Preferably, each host can be a member of only one pool at a time (i.e., the pools are mutually exclusive). A pool may be allocated exclusively to a particular project to provide the project members with a set of private machines, or may be allocated to multiple concurrent projects such that the pool's resources are shared. In one embodiment, multiple pools of hosts may be used within a single test run. In another embodiment, only a single pool may be used for a given test run.

Management of timeslot reservations and test runs—Administrators can view and cancel timeslot reservations in all projects. In addition, Administrators can view the states, machine assignments, and other details of test runs across all projects.

The Privilege Manager 134 is preferably implemented as a separate set of web pages that are accessible from links on the User site 130 and the Administration site 132. Using the Privilege Manager pages, authorized users can perform such actions as view and modify user information; specify the access privileges of other users; and view and modify information about ongoing projects. The specific actions that can be performed by a user via the Privilege Manager 134 depends upon that user's privilege level. The following is a brief summary of some of the functions that are preferably embodied within the Privilege Manager 134. Additional details of one implementation of the Privilege Manager 134 are described in section V below.

Managing Users—The Privilege Manager 134 includes functions for adding and deleting users, assigning privilege levels to users, and assigning users to projects (to control which projects they may access via the User site). In a preferred embodiment, a user may only manage users having privilege levels lower than his or her own privilege level.

Restricting projects to specific target systems—The Privilege Manager 134 also allows users of appropriate privilege levels to specify, for each project, which target system or systems 102 may be load tested. Attempts to load test systems other than the designated targets are automatically blocked by the system 100. This feature reduces the risk that the system's resources will be used for denial of service attacks or for other malicious purposes.

Defining Privilege Levels—The Privilege Manager 134 also includes functions for defining the access rights associated with each privilege level (and thus the actions that can be performed by users with such privilege levels). In addition, new privilege levels can be added to the system, and the privilege level hierarchy can be modified.

With further reference to FIG. 1, some or all of the components of the load testing system 100 may reside in a centralized location or lab. For example, a company wishing to load test its various web or other server systems may install the various software components of the system on a set of computers on a corporate LAN, or on a server farm set up for load testing. If desired, the company may also install Vuser components 104 on one or more remote computers, such as on a LAN or server farm in a remote office. These remote Vusers/load generator hosts 104 are preferably controlled over the Internet (and over a firewall of the central location) by controllers 120 in the centralized location.

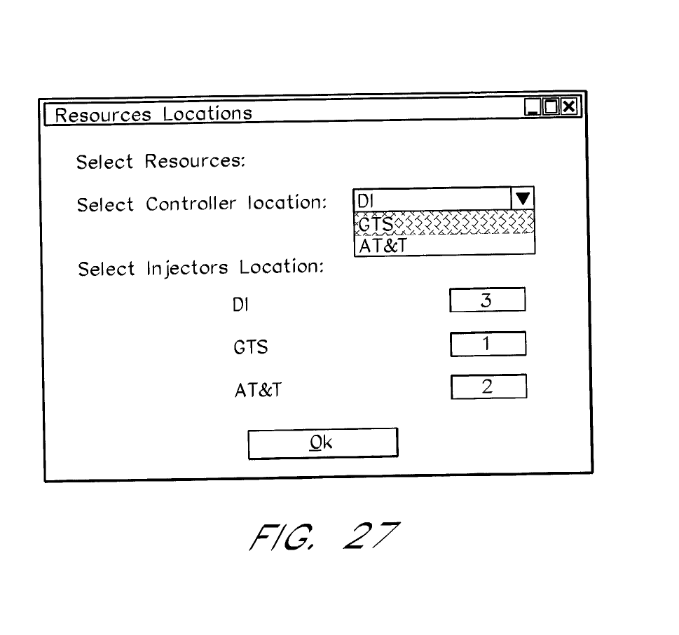

More generally, any one or more of the system's components may be installed remotely from other components to provide a geographically distributed testing system with centralized control. For example, controllers 120 or entire testing labs may be set up in multiple geographic locations, yet may work together as a single testing system 100 for purposes of load testing. Components that are remote from one another communicate across a WAN (Wide Area Network), and where applicable, over firewalls. In one embodiment depicted in FIG. 27 (discussed below), a tester may specify the locations of the host machines to be used as controllers and load generators (injectors) within a particular test.

Once the system 100 components have been installed, users in various geographic locations may be assigned appropriate privilege levels and access rights for defining, running, administering, and viewing the results of load tests. As depicted in FIG. 1, each such user typically accesses the system 100 remotely via a browser running on a PC or other computing device 140.

II. Typical Usage Scenario

The load testing system 100 may advantageously be used to manage multiple, concurrent load testing projects. In a typical company-specific installation, users with administrative privileges initially specify, via the Administration site 132, which host computers on the company's network may be used for load testing. Host computers in multiple different office locations and geographic regions may be selected for use in some embodiments. If desired, the hosts may be subdivided into multiple pools for purposes of controlling which hosts are allocated to which projects. Alternatively, the entire collection of hosts may be shared by all projects. In addition, specific purposes may be assigned to some of all of the hosts (e.g., load generator, controller, and/or analyzer).

An administrator may also specify criteria for controlling how such hosts are automatically assigned to test runs. Preferably, this is accomplished by assigning host priority levels that specify an order in which available hosts are to be automatically selected for use within test runs. In some embodiments, an administrator can also specify host-specific availability schedules that specify when each host can be automatically selected for use. For instance, a server on the company's internal network may be made available for use during night hours or other non-business hours, such that its otherwise unutilized processing power may be used for load testing.

As load testing projects are defined within the system 100, one or more pools of hosts may be allocated by an administrator to each such project. In addition, a group or team of users may be assigned (given access rights) to each such project. For instance, a first group of users may be assigned to a first project to which a first pool of hosts is allocated, while a second group of users may be assigned to a second project to which the first pool and a second pool are allocated. Because the entire load testing process may be controlled remotely using a web browser, the users assigned to a particular project may be located in different offices, and may be distributed across geographic boundaries.

Each project may, for example, correspond to a respective Web site, Web application, or other target system 102 to be tested. Different members of a project may be responsible for testing different components, transactions, or aspects of a particular system 102. The IP addresses of valid load testing targets may be specified separately for each project within the system.

During the course of a project, members of the project access the User site 130 to define, run and analyze load tests. As part of this process, the project members typically create Vuser scripts that define the actions to be performed by Vusers. Project members may also reserve hosts via the User site 130 during specific timeslots to ensure that sufficient processing resources will be available to run their load tests. In one embodiment, a timeslot reservation must be made in order for testing to commence.

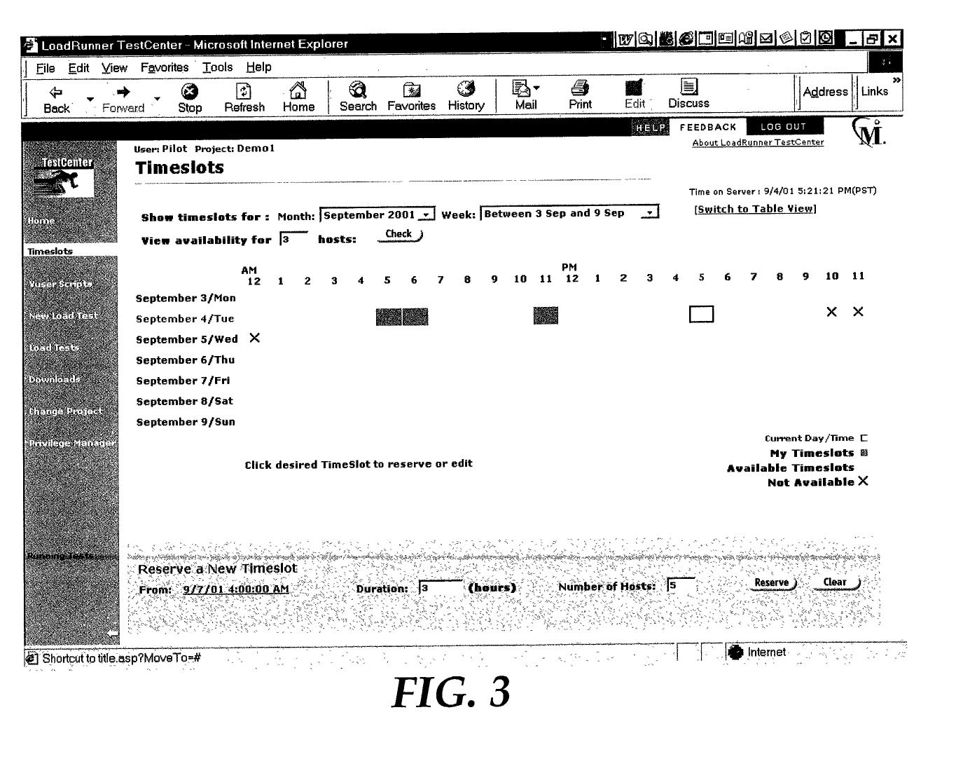

As part of the scheduling process, a user preferably accesses a Timeslots page (FIG. 3) which displays information about timeslot availability. From this page, the user may specify one or more desired timeslots and a number of hosts needed. If the requested number of hosts are available within the pool(s) allocated to the particular project during the requested time period, the timeslot reservation is made within the system. Timeslot reservations may also be edited and deleted after creation. The process of reserving processing resources for specific timeslots is described in detail in the following sections.

To define or configure a load test, various parameters are specified such as the number of hosts to be used, which Vuser script or scripts are to be run by the Vusers, the duration of the test, the number of Vusers, the load ramp up (i.e. how many Vusers of each script will be added at each point of time), the runtime settings of the Vusers, and the performance parameters to be monitored. These and other parameters may be interactively monitored and adjusted during the course of a test run via the User site 130. A single project may have multiple concurrently running load tests, in which case the hosts allocated to the project may automatically be divided between such tests. Members of a project may view and analyze the results of the project's prior test runs via a series of online graphs, reports, and interactive analysis tools through the User site 130.

In general, each non-administrative user of the User site 130 sees only the data or “work product” (Vuser scripts, load tests, run status, test results, comments, etc.) of the project or projects of which he is a member. For instance, when a user logs in to the User site 130 through a particular project, the user is prevented from accessing the work product of other projects. This is particularly desirable in scenarios in which different projects correspond to different companies or divisions.

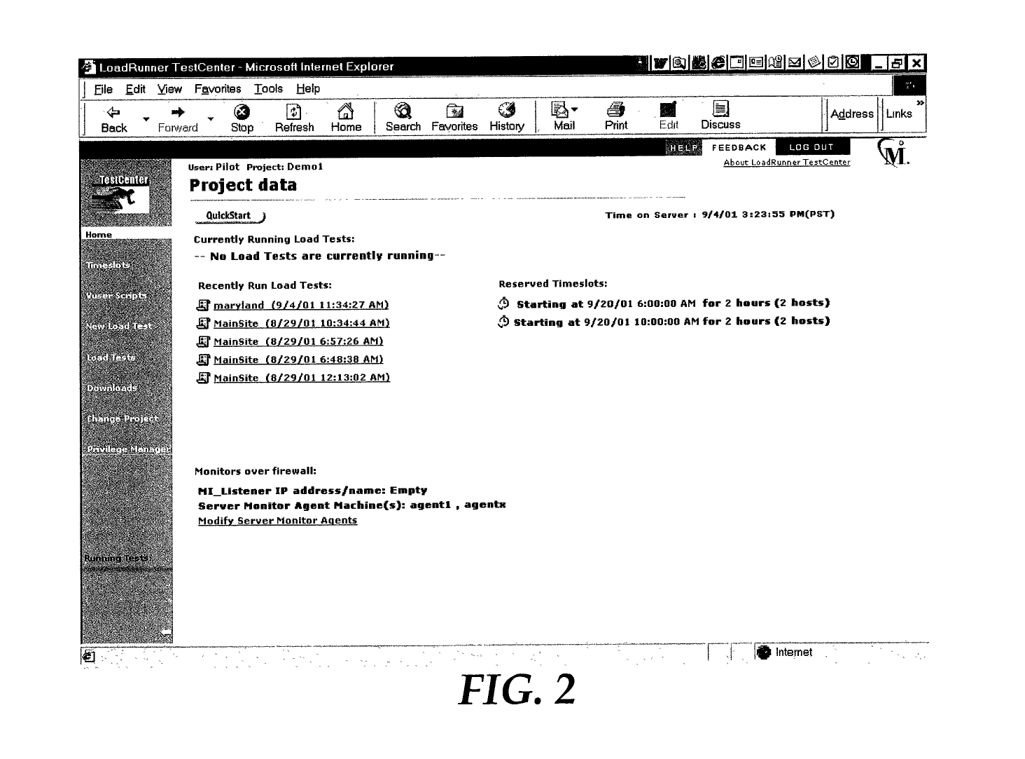

Preferred embodiments of the User site 130, the Administration site 132, and the Privilege Manager 134 will now be described with reference to the example web pages shown in FIGS. 2-24. It should be understood that these web pages, and the functions they perform, represent just one example of a set of user interfaces and functions that may be used to practice the invention, and that numerous modifications are possible without departing from the scope of the invention.

The example web pages are shown populated with sample user, project and configuration data for purposes of illustration. The data displayed in and submitted via the web pages is stored in the repository 118, which may comprise multiple databases or servers as described above. The various functions that may be performed or invoked via the web pages are embodied within the coding of the pages themselves, and within associated application code which runs on host machines (which may include the web server machines) of the system 100. In some of the figures, an arrow has been inserted (in lieu of the original color coding) to indicate the particular row or element that is currently selected.

III. User Web Site

A preferred embodiment of the User site 130 will now be described with reference the example web pages shown in FIGS. 2-6. This description is illustrative of a tester's perspective of the load testing system 100.

A. Navigation Menu

As illustrated in FIG. 2 and subsequent figures, the various pages of the User site 130 include a navigation menu with links to the various pages and areas of the site. The following links are displayed in the navigation menu.

Home—Opens the Home page (FIG. 2) for the currently selected project.

Timeslots—Opens the Timeslots page (FIG. 3), from which the user may reserve timeslots and view available timeslots.

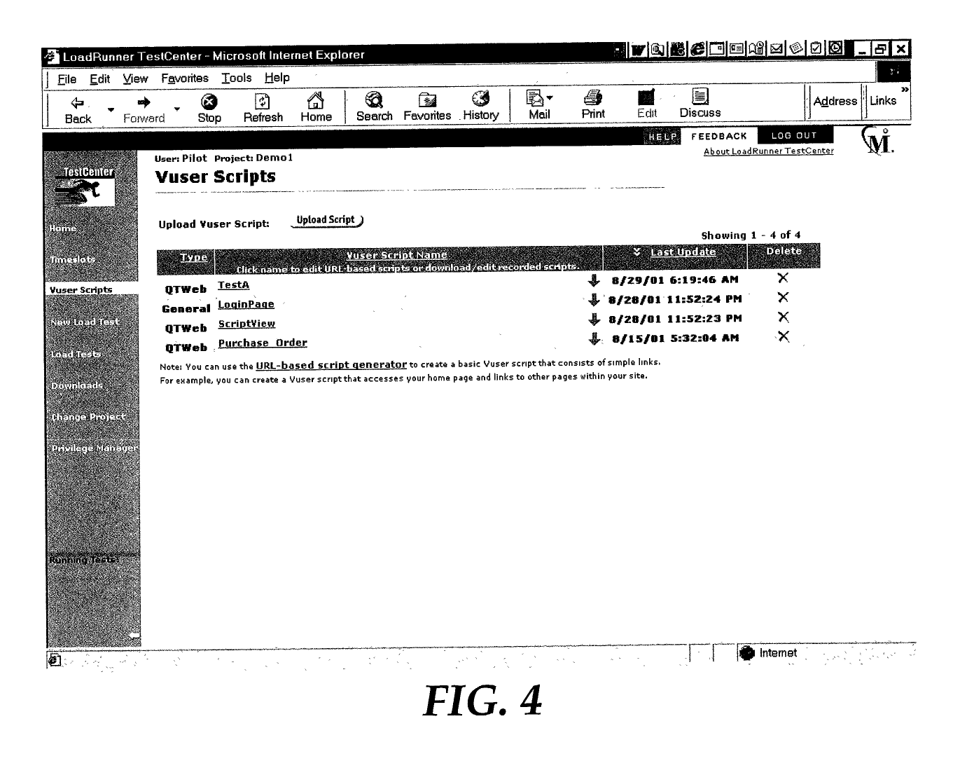

Vuser Scripts—Displays the Vuser Scripts page (FIG. 4), which includes a list of all existing Vuser scripts for the project. From the Vuser Scripts page, the user can upload a new Vuser script, download a Vuser script for editing, create a URL-based Vuser script, or delete a Vuser script.

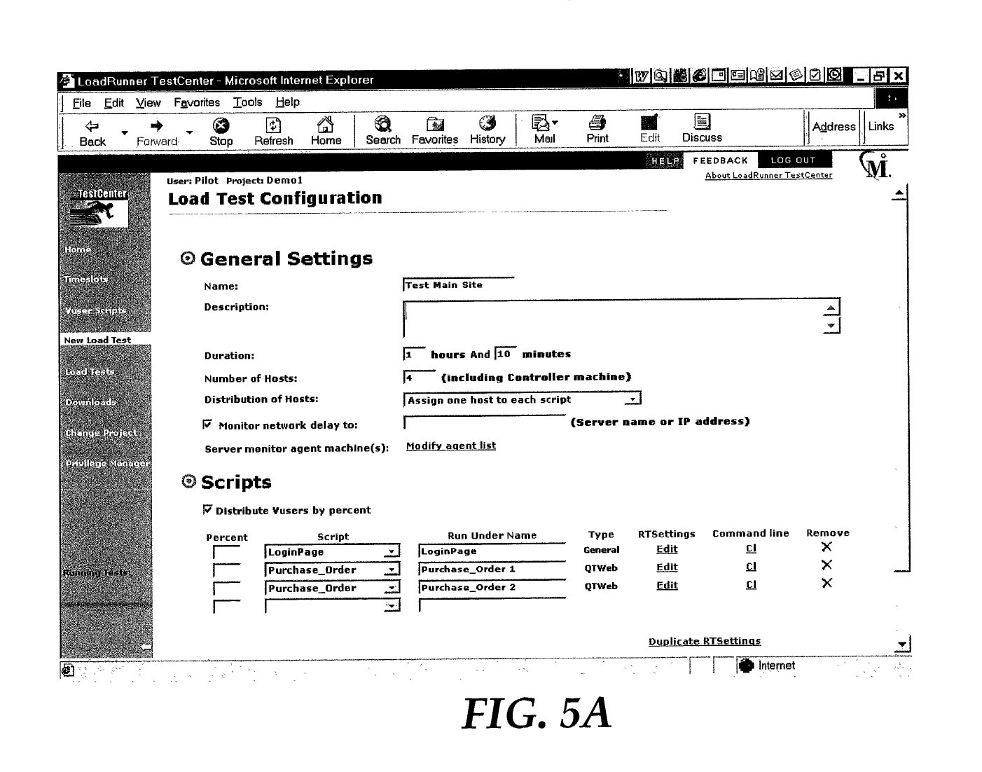

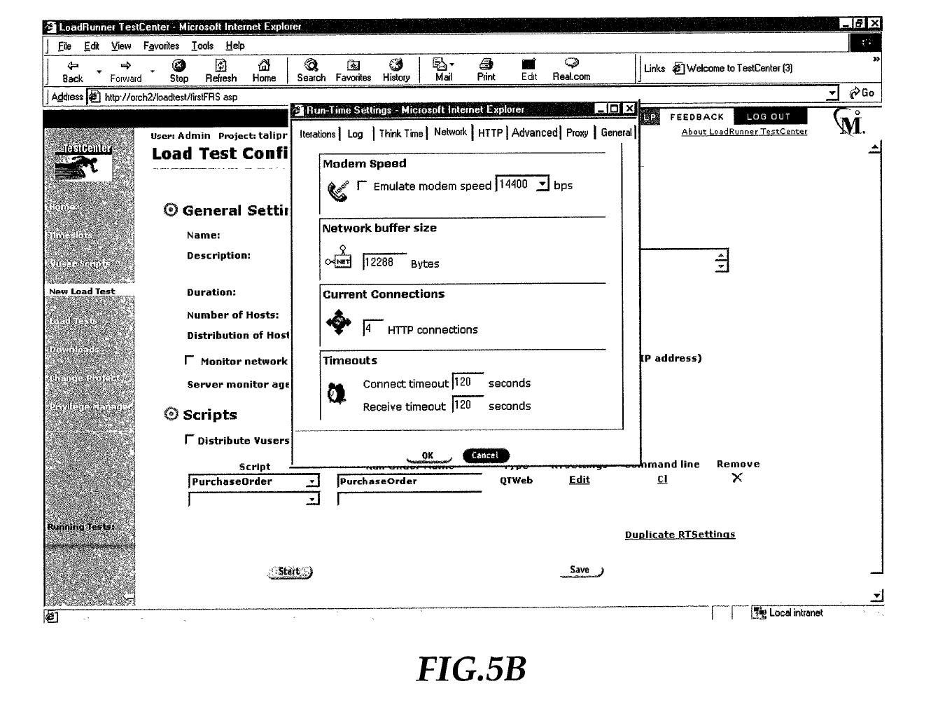

New Load Test—Displays the Load Test Configuration page (see FIG. 5A), which allows the user to create a new load test or modify an existing load test.

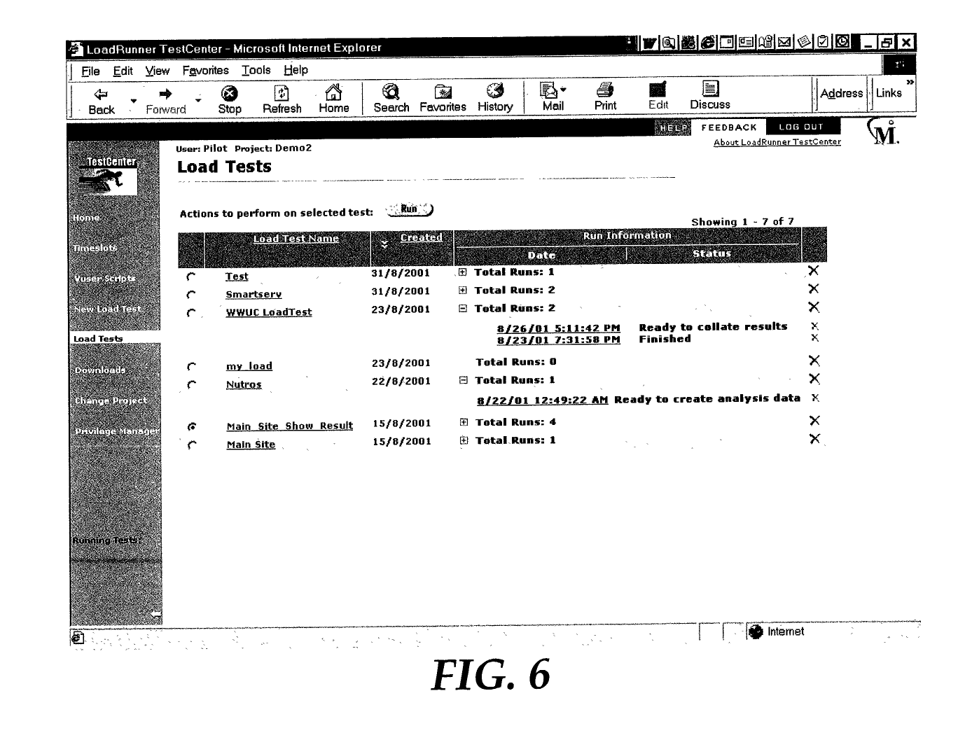

Load Tests—Displays the Load Tests page (see FIG. 6), which lists all existing load tests and test runs for the project. From the Load Tests page, the user can initiate the following actions: run a load test, edit a load test, view the results of a load test run, and view a currently running load test.

Downloads—Displays the Downloads page (not illustrated), from which the user can download a Vuser script recorder, a “Monitors over Firewall” application, and other components. The Monitors over Firewall application allows the user to monitor infrastructure machines from outside a firewall, by designating machines inside the firewall as server monitor agents.

Change Project—Allows the user to switch to a different project to which he/she has access rights.

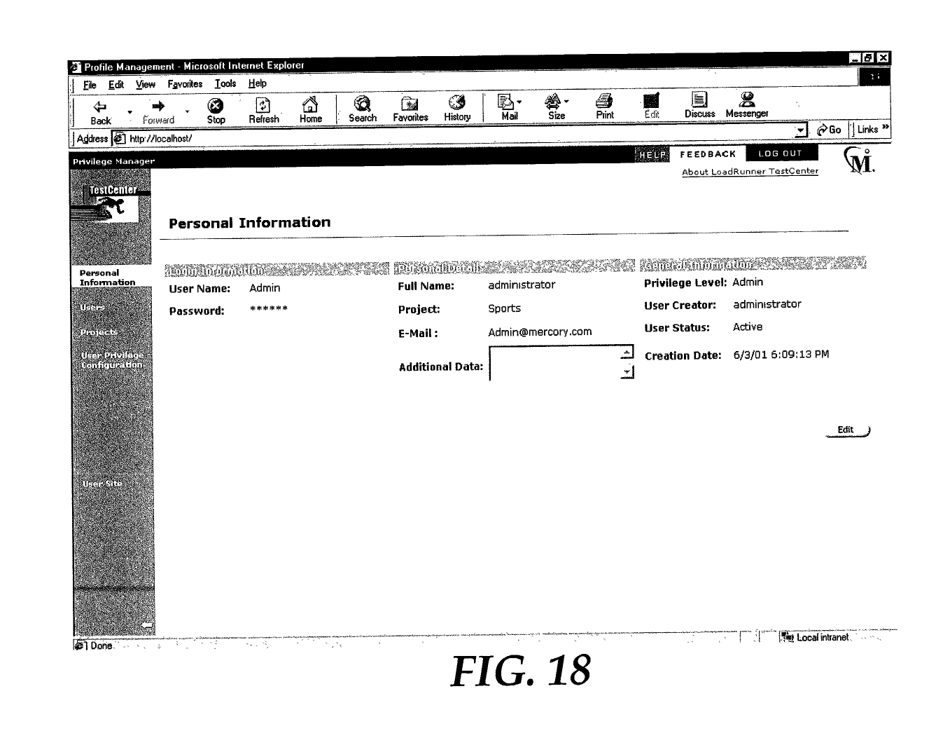

Privilege Manager—Brings up the Privilege Manager (FIGS. 18 to 24), which is described in section V below. The Privilege Manager pages include links back to the User site 130.

B. Home and Project Selection Pages

When a user initially logs in to the User site 130, the user is presented with a Select Project page (not shown) from which the user can either (a) select a project from a list of the projects he or she belongs (has access rights) to, (b) select the Privilege Manager 134. Upon selecting a project, the home page for that project is opened. If the user belongs to only a single project, the home page for that project is presented immediately upon logging in. Users are assigned (given access rights) to projects via the Privilege Manager 134, as discussed in section V below.

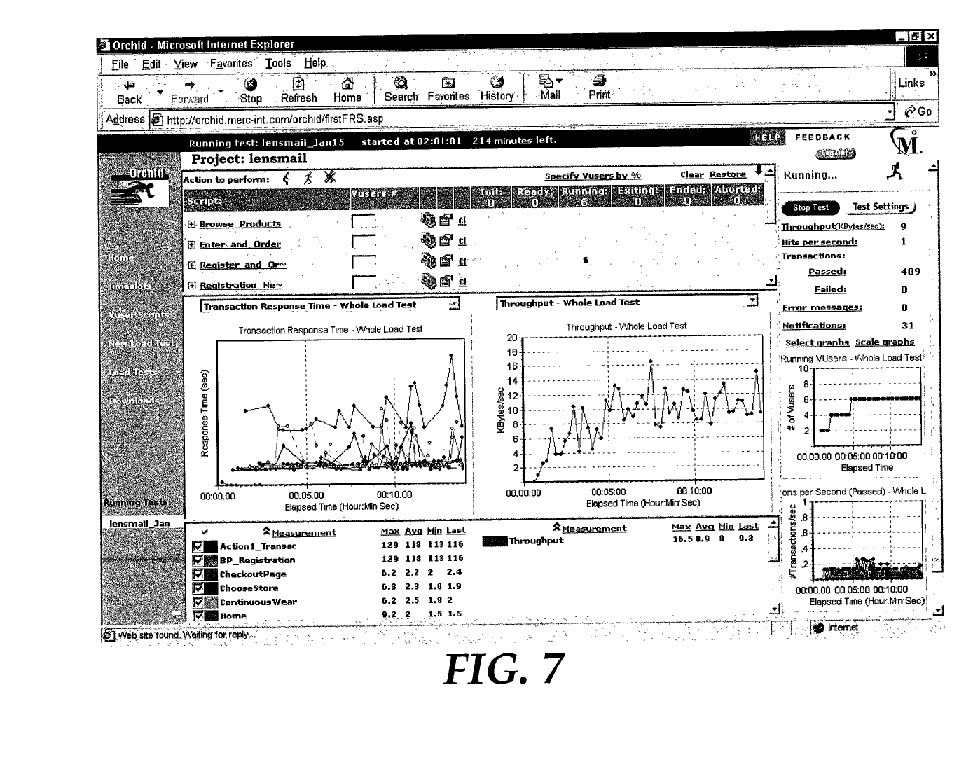

FIG. 2 illustrates an example Home page for a project. This page displays the name of the project (“Demo1” in this example), a link (labeled “QuickStart”) to an online users guide, and various types of project data for the project. The project information includes a list of any load tests that are currently running (none in this example), a list of the most recently run load tests, and information about upcoming timeslot reservations for this project. From this page, the user can select the name of a running load test to monitor the running test in real time (see FIG. 7), or can select the name of recently run load test to view and perform interactive analyses of the test results. Also displayed is information about any components being used to monitor infrastructure machines over a firewall.

A “feedback” link displayed at the time of the Home page allows users to enter feedback messages for viewing by administrators. Feedback entered via the User site or the Privilege Manager is viewable via the admin site 132, as discussed below.

C. Timeslots Page

FIG. 3 illustrates one view of an example Timeslots page of the User site 130. From this page, the user can view his or her existing timeslot reservations, check timeslot availability, and reserve host resources for a specific timeslot (referred to “reserving the timeslot”). Preferably, timeslots can be reserved before the relevant load test or tests have been created. Using the fields at the top of the Timeslots page, the user can specify a desired time window and number of hosts for which to check availability. When the “check” button is selected, the repository 118 is accessed to look up the relevant timeslot availability data for the hosts allocated to the particular project. This resulting data, including available timeslots, unavailable timeslots, and timeslots already reserved to the user, are preferably presented in a tabular “calendar view” as shown. The user may switch to a table view to view a tabular listing (not shown) of all timeslot reservations, including the duration and number of hosts of each such reservation.

To create or edit a timeslot reservation (which may comprise multiple one-hour timeslots), the user may select a one-hour timeslot from the calendar view, and then fill in or edit the corresponding reservation data (duration and number of hosts needed) at the bottom of the page. Upon selecting the “reserve” button, the repository 118 is accessed to determine whether the requested resources are available for the requested time period. If they are available, the repository 118 is updated to reserve the requested number of hosts for the requested time period, and the display is updated accordingly; otherwise the user is prompted to revise the reservation request.

In this embodiment, different members of the same project may reserve their own respective timeslots, as may be desirable where different project members are working on different load tests. In other embodiments, timeslot reservations may additionally or alternatively be made on a per-project basis.

As discussed below, in other embodiments, users may be permitted to do one or more of the following when making a timeslot reservation: (a) designate specific hosts to be reserved; (b) designate the number of hosts to be reserved in each of multiple locations; (c) designate a particular host, or a particular host location, for the controller.

In addition, users may be permitted to reserve processing resources in terms processing units other than hosts. For instance, rather than specifying the number of hosts needed, the user creating the reservation may be permitted or required to specify the number of Vusers needed or the expected maximum load to be produced. The expected load may be specified in terms of number of requests per unit time, number of transactions per unit time, or any other appropriate metric. In such embodiments, the system 100 may execute an algorithm that predicts or determines the number of hosts that will be needed. This algorithm may take into consideration the processing power and/or the utilization level of each host that is available for use.

As described below, the timeslot reservations are accessed at load test run time to verify that the user requesting the test run has a valid timeslot reservation, and to limit the number of hosts used within the testing session.

D. Vuser Scripts Page

FIG. 4 illustrates a Vuser Scripts page of the User site 130. This page lists the Vuser scripts that exist within the repository for the current project. From this page, the user can upload new Vuser scripts to the repository 118 (by selecting the “upload script” button and then entering a path to a script file); download a script for editing, invoke a URL-based script generator to create a script online, or delete a script. The scripts may be based on any of a number of different protocols (to support testing of different types of target systems 102), including but not limited to Web (HTTP/HTML), WAP (Wireless Access Protocol), VoiceXML, Windows Sockets, Baan, Palm, FTP, i-mode, Informix, MS SQL Server, COM/DCOM, and Siebel DB2.

E. Load Test Configuration Page

FIG. 5A illustrates an example Load Test Configuration page of the User site 130. Typically, a user will access this page after one or more Vuser scripts exists within the repository 118, and one or more timeslots have been reserved, for the relevant project. To define or configure a load test from this page, the user enters a load test name, and optional description, a load test duration in hours and minutes, a number of hosts (one of which serves as a controller host 120 in the preferred embodiment), and the Vuser script or scripts to be used (selected from those currently defined within the project).

For each selected Vuser script, the user can select the “RTSettings” link to specify run-time settings. A script's run-time settings further specify the behavior of the Vusers that run that script. FIG. 5B illustrates the “network” tab of the “run-time settings” window that opens when a RTSettings link is selected. As illustrated in FIG. 5B, the network run-time settings include an optional modem speed to be emulated, a network buffer size, a number of concurrent connections, and timeout periods. Other run-time settings that may be specified (through other tabs) include the number of iterations (times the script should be run), the amount of time between iterations, the amount of “think time” between Vuser actions, the version of the relevant protocol to be used (e.g., HTTP version 1.0), and the types of information to be logged during the script's execution. The run-time settings may be selected such that each Vuser produces a load equivalent to that of a single user or of a larger number of users.

The Load Test Configuration page of FIG. 5A also includes a drop-down list for specifying an initial host distribution. The host distribution options that may be selected via this drop down list are summarized in Table 1. The user may also select the “distribute Vusers by percent” box, and then specify, for each selected script, a percentage of Vusers that are to run that script (note that multiple Vusers may run on the same host). The host distribution settings may be modified while the load test is running. As described above, hundreds or thousands of Vusers may run on the same host.

TABLE 1

| Host | |
|---|---|
| Distribution | |
| Option | Action Performed |
| Assign one | One host is assigned to each script. If the number of hosts |
| host to | is less than the number of scripts, some scripts will not be |
| each script | assigned hosts (and therefore will not be executed). If the |
| | number of hosts exceeds the number of scripts, not all hosts |
| | will be assigned to scripts. |
| Assign all | All hosts are assigned to each script. |
| hosts to | |
| each script | |
| Divide hosts | The hosts are automatically distributed among all scripts on |
| equally | an equal basis. If there are hosts left over, they will be |
| among | distributed as equally as possible. |
| scripts | |
| Manual | Hosts are not automatically assigned to scripts prior to the |
| distribution | load test run. The user assigns hosts to scripts manually |
| during load | while the load test is running. |
| test run | |

With further reference to FIG. 5A, if the user wishes to monitor the network delay to a particular server during running of the load test, the user may check the “monitor network delay to” box and specify the URL or IP address of the server. In addition, the user can select the “modify agent list” link to specify one or more server monitor agents to be used within the test. Once all of the desired load test configuration settings have been entered, the user can select the “start” button to initiate running of the load test, or select the “save” button to save the load test for later use.

F. Load Tests Page

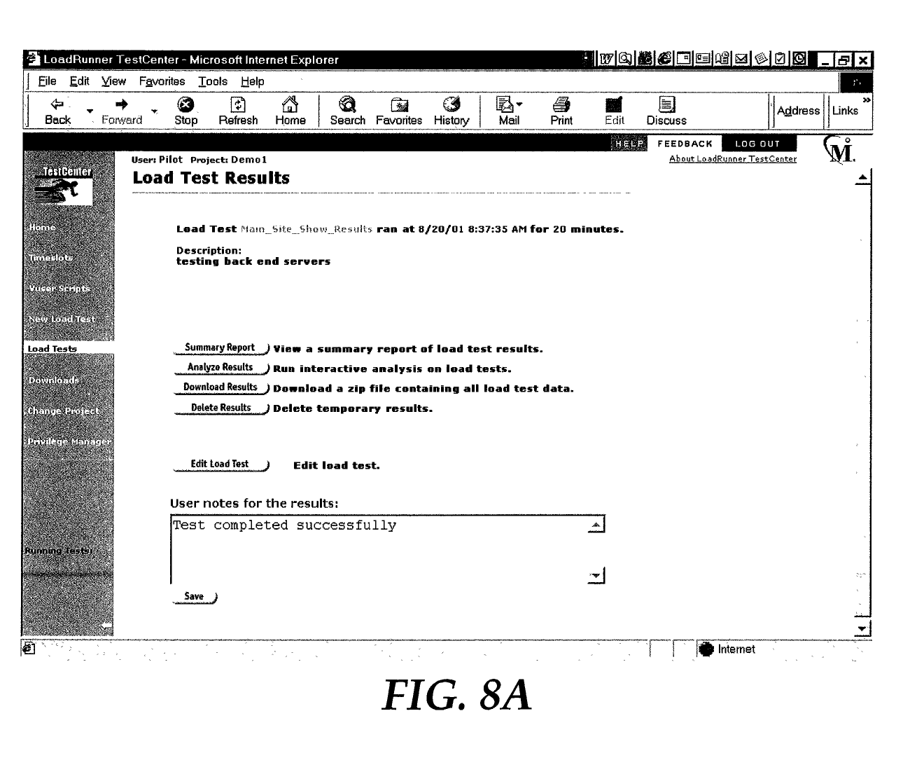

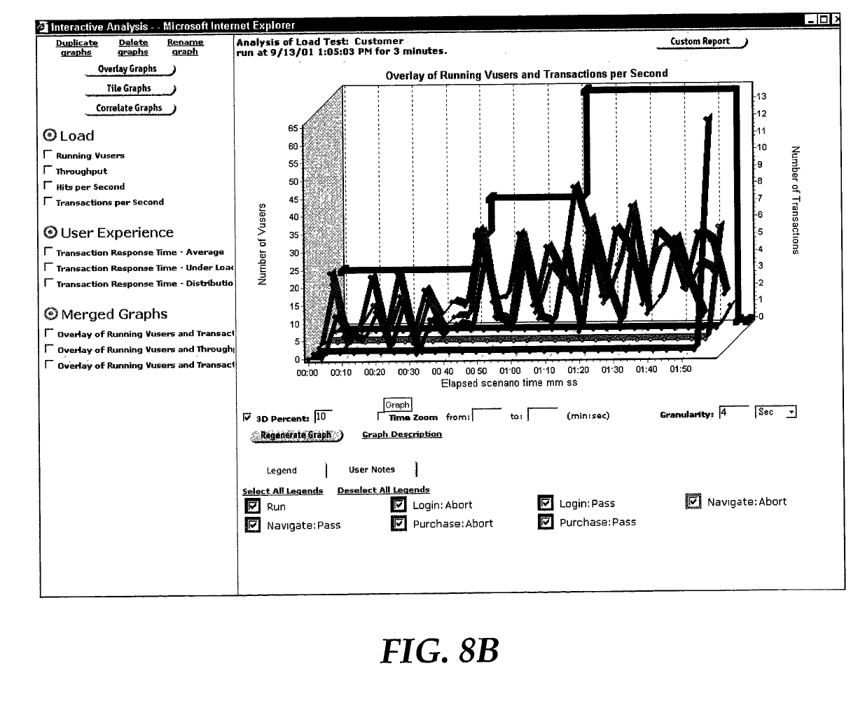

FIG. 6 illustrates the Load Tests page of the User site 130. This page presents a tabular view of the load tests that are defined within the project. Each load tests that has been run is presented together with an expandable listing of all test runs, together with the status of each such run. From this page, the user can perform the following actions: (1) select and initiate immediate running of a load test, (2) click on a load test's name to bring up the Load Test Configuration page (FIG. 5A) for the test; (3) select a link of a running load test to access the Load Test Run page (FIG. 7) for that test; (4) select a link of a finished test run to access the Load Test Results page (FIG. 8A) for that run, or (5) delete a load test.

G. Load Test Run Page

FIG. 7 illustrates a Load Test Run page of the User site 130. From this page, a user can monitor and control a load test that is currently running. For example, by entering values in the “Vusers #” column, the user can specify or adjust the number of Vusers that are running each script. The user can also view various performance measurements taken over the course of the test run, including transaction response times and throughput measurements. Once the test run is complete, the test results data is stored in the repository 118.

H. Load Test Results Page

FIG. 8A illustrates a Load Test Results page for a finished test run. From this page, the user can (1) initiate generation and display of a summary report of the test results, (2) initiate an interactive analysis session of the results data (FIG. 8B); (3) download the results; (4) delete the results; (5) initiate editing of the load test; or (6) post remarks. Automated analyses of the test run data are performed by the analyzer component 124A, which may run on a host 124 that has been assigned to the project for analysis purposes.

IV. Administration Web Site

A preferred embodiment of the Administration site 132 will now be described with reference to example web pages. This description is illustrative of an administrator's perspective of the load testing system 100.

The Administration site 132 provides various functions for managing load test resources and supervising load testing projects. These functions include controlling how hosts are allocated to projects and test runs, viewing and managing timeslot reservations, viewing and managing test runs, and viewing and managing any errors that occur during test runs. Unlike the view presented to testers via the User site 130, an authorized user of the admin site can typically access information associated with all projects defined within the system 100.

A. Navigation Menu

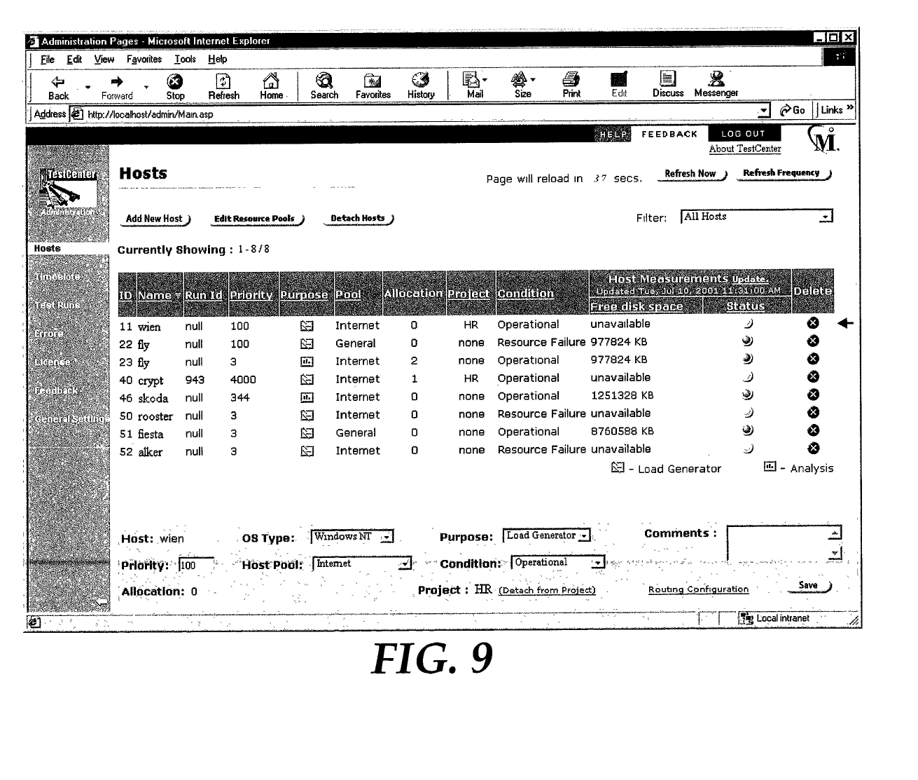

As illustrated in FIG. 9 and subsequent figures, a navigation menu is displayed at the left hand side of the pages of the Administration site 132. The following links are available from this navigation menu:

Hosts—Displays the Hosts page (see FIG. 9), which indicates the allocation, availability, and various properties of the hosts defined within the system, as discussed below. The Hosts page also provides various functions for managing hosts.

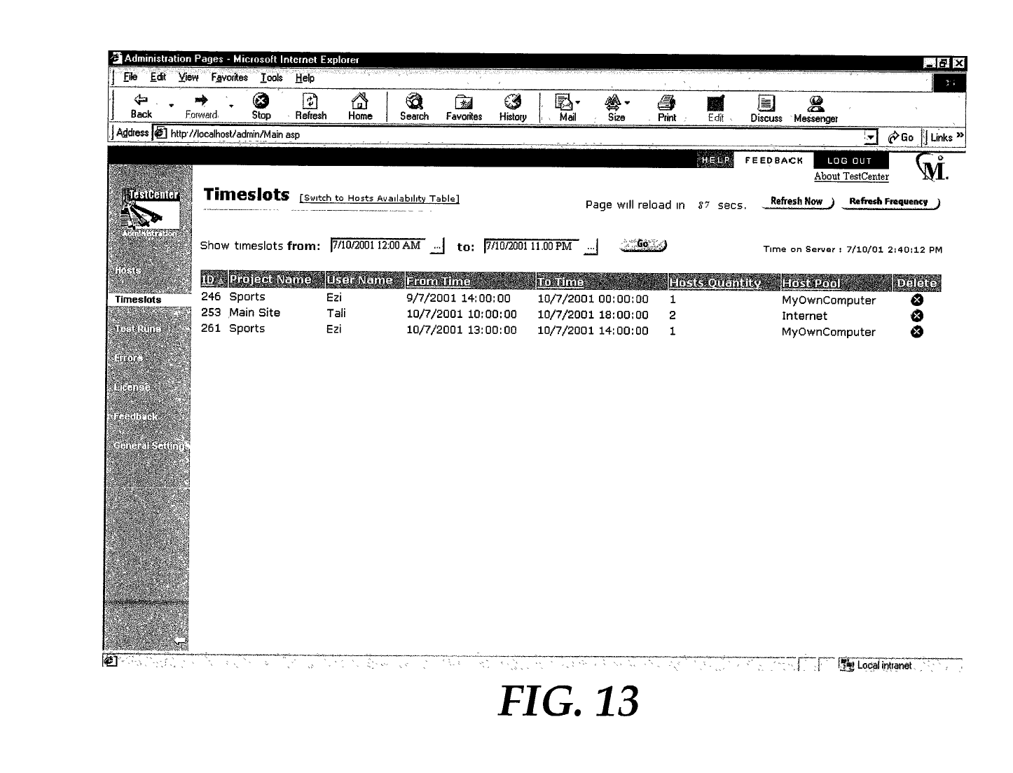

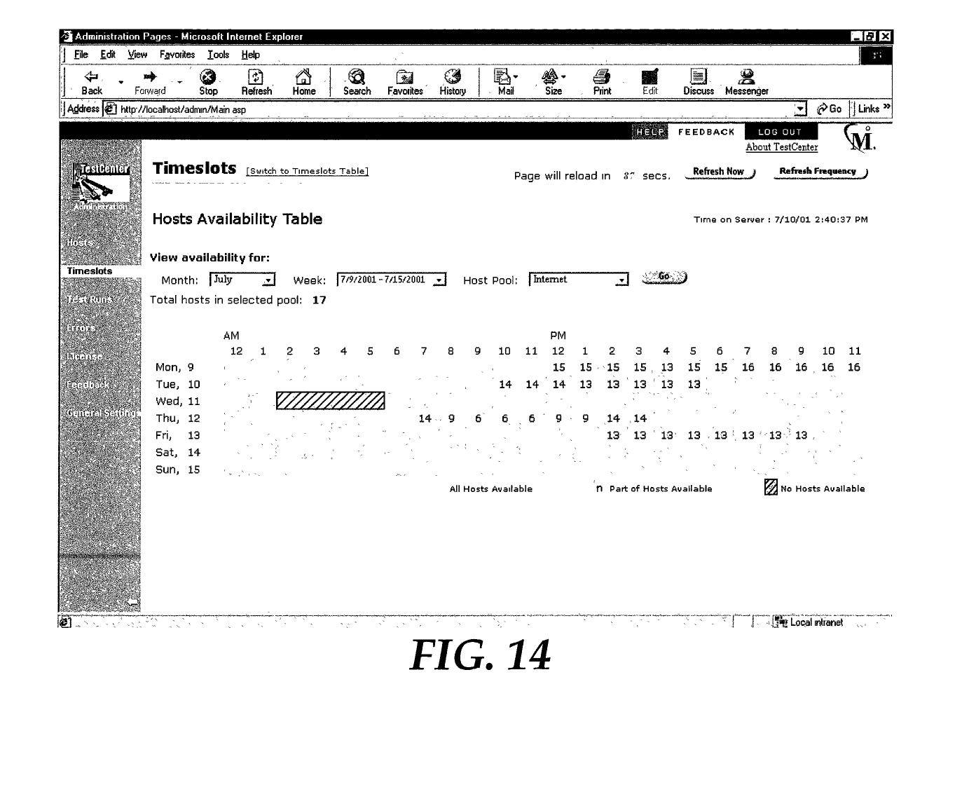

Timeslots—Displays the Timeslots pages (see FIGS. 13 and 14), which display and provide functions for managing timeslot reservations.

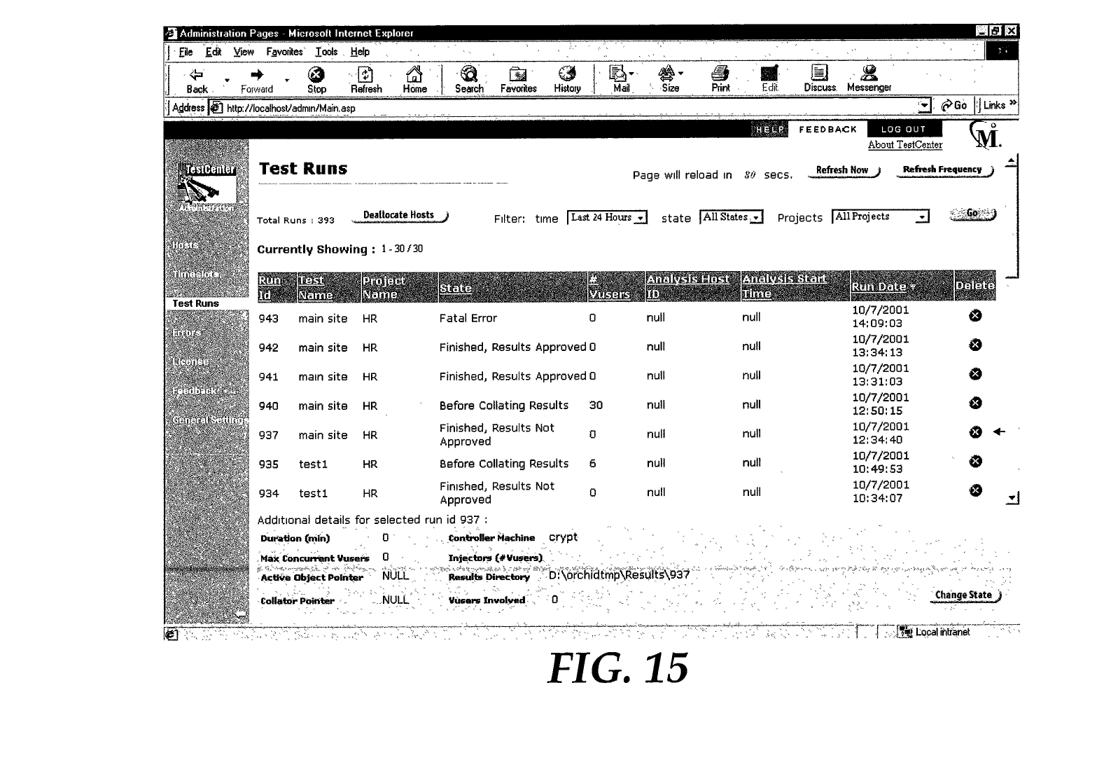

Test Runs—Displays the Test Runs page (FIG. 15), which displays the states of test runs and provides various services for managing test runs.

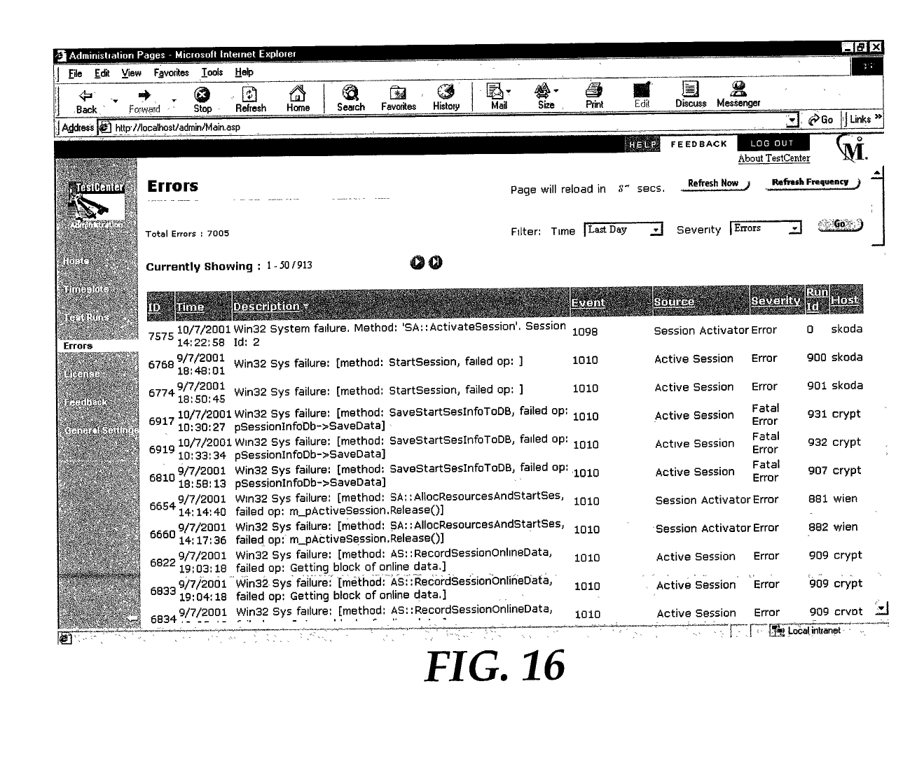

Errors—Displays an Errors page (FIG. 16), which displays and provides services for managing errors detected during test runs or other activity of the system 100.

License—Displays license information associated with the components of the system 100.

Feedback—Displays a Feedback page (not shown), which displays and provides services for managing feedback messages entered by users of the User site and the Privilege Manager.

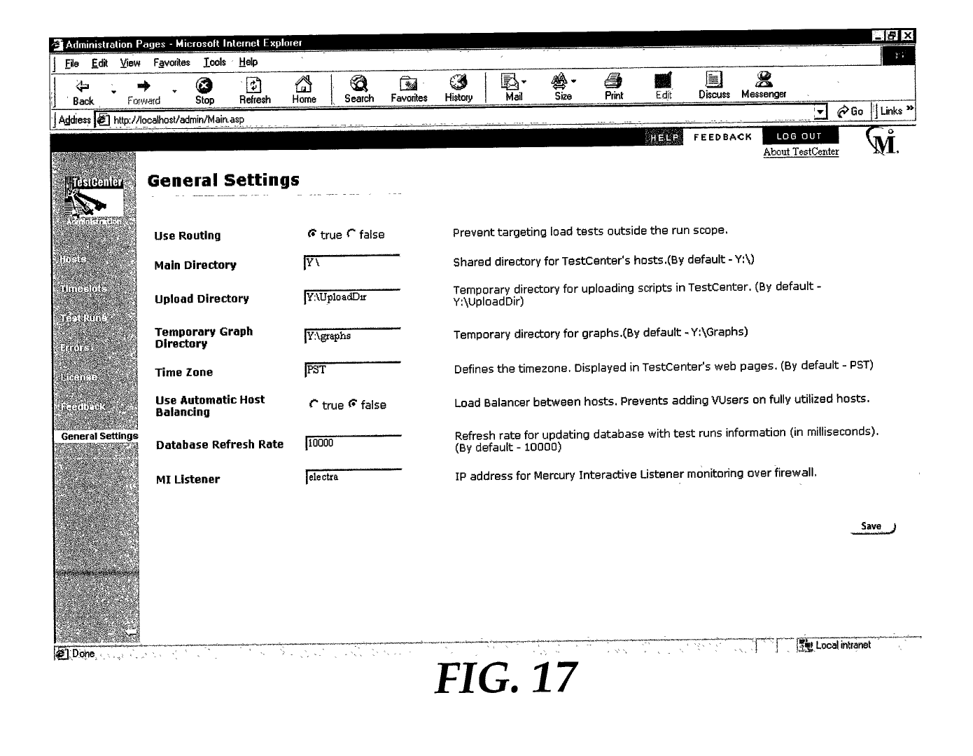

General Settings—Displays the General Settings page (FIG. 17), from which general system configuration settings can be specified.

B. Host and Pool Management Pages

FIG. 9 illustrates the Hosts page of the admin site 132. The Hosts page and various other pages of the admin site 132 refresh automatically according to a default or user-specified refresh frequency. This increases the likelihood that the displayed information accurately reflects the status of the system 100. A “refresh frequency” button allows the user to change to refresh frequency or disable automatic refreshing.

The table portion of the Hosts page contains information about the hosts currently defined within the system. This information is summarized below in Table 2. Selection of a host from this table allows certain settings for that host to be modified, as shown for the host “wein” in FIG. 9. Selection of the “delete” link for the host causes that host to be deleted from set of defined hosts that may be used for load testing.

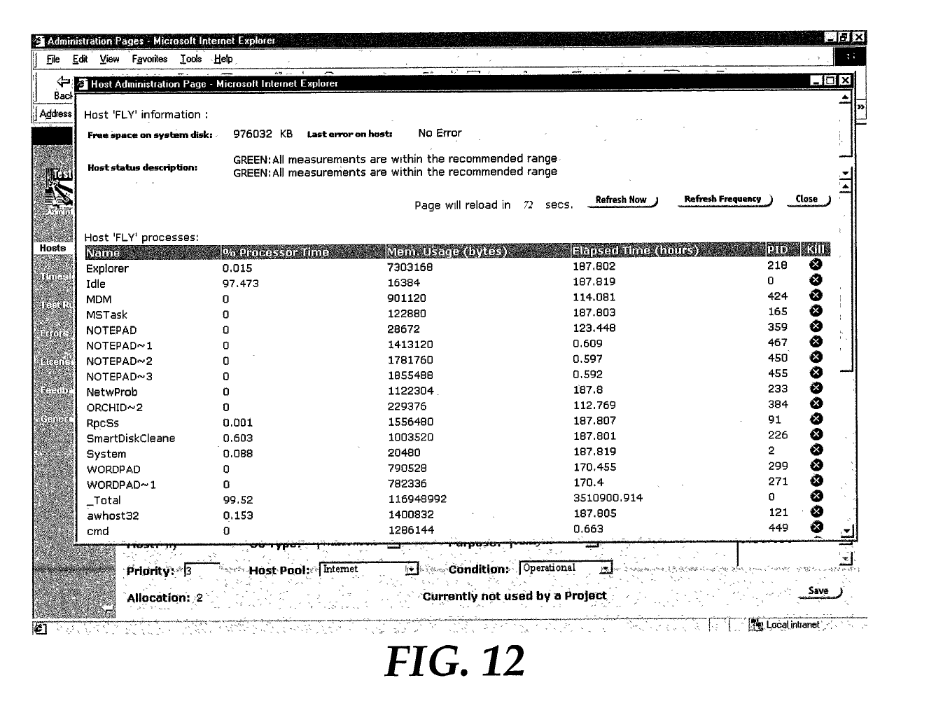

TABLE 2
Host Properties

| Field | Description |
|---|---|
| ID | The host ID number, which is automatically assigned when a new host |
| | is added. |
| Name | The host name. A host name is assigned when the host is added. |
| | Clicking on a host's name causes the Host Administration Page |
| | (FIG. 12) to be displayed for the host. |
| Run ID | The ID number of the test run for which the host is currently being |
| | used. If the host is currently not being used for a test run, and is |
| | therefore available, this field displays “null.” |
| Priority | A rank assigned to the host. The higher the priority assigned to the |
| | host, the more likely the host is to be allocated to a test. A host's rank |
| | is assigned when the host is added, and may thereafter be edited. |
| Purpose | The function for which the host may be used in any test run to which it |
| | may be allocated. In the embodiment depicted by the example screen |
| | displays, a host may be designated as a “load generator” or an |
| | “analysis” manager, and those designated as “load generators” may |
| | also be used as a controller. In other embodiments, a host may also be |
| | designated as a “controller.” “Purpose” is one of the parameters the |
| | system 100 uses to allocate hosts for test runs, as discussed in section |
| | VII below. |
| Condition | The condition of the host. “Operational” indicates that the host is |
| | working. “Resource failure” indicates that a problem occurred that |
| | stopped the host from working. “Out of Order” indicates that the host is |
| | currently not working for some other reason, such as for failure to |
| | install the appropriate load testing software on the host. |
| Pool | The pool to which the host is assigned. Pools allow administrators to |
| | control which hosts are allocated to which projects. When allocating |
| | hosts for a test, the system allocates hosts with the pool specified for |
| | the project in the project profile. Preferably, the same pool may |
| | concurrently be allocated to more than one project, and these projects |
| | may concurrently use that pool (but not the same host of that pool at |
| | the same time) to perform test runs. |
| Allocation | The number of test runs to which the host is currently allocated. If the |
| | host is a load generator, it can be allocated to one or zero tests in the |
| | preferred embodiment, and generally to a configured number. If the |
| | host is an analysis machine, it can be allocated to up to x tests in the |
| | preferred embodiment, where x is defined by an administrator of |
| | system 100. |
| Project | The project currently using the host. The project name remains after a |
| | test run is complete, until the host is detached from the project or |
| | allocated to another test. |
| Free Disk | The disk space available on the machine. |
| Space | |
| Status | An indicator of the machine's current system performance, |
| | represented by a color indicator. The performance is preferably |
| | assessed according to three parameters: CPU usage, memory usage, |
| | and disk space, each of which has a threshold. Green indicates that all |
| | three performance parameters are within their thresholds, and that the |
| | host is suitable for running a test. Yellow indicates that one or two of |
| | the performance parameters are within their thresholds. Red indicates |
| | that all three performance parameters are outside their thresholds, and |
| | that the host is not recommended for running tests. Grey indicates that |
| | the information is not available. Selection of the color-coded indicator |
| | causes the Host Administration Page for that host to be opened |
| | (FIG. 12). |

With further reference to FIG. 9, a “filter” drop down list allows the user to select a filter to control which hosts are displayed in the table. The filter options are as follows: All Hosts; Allocated Hosts for Load Tests (displays only hosts that are currently allocated to a load test); Allocated Hosts for Analysis (displays only hosts used for results analysis); Free Hosts for Load Test (displays only hosts that are available to be used as load machines); Free Hosts for Analysis (displays only hosts that are available to be used as analysis machines).

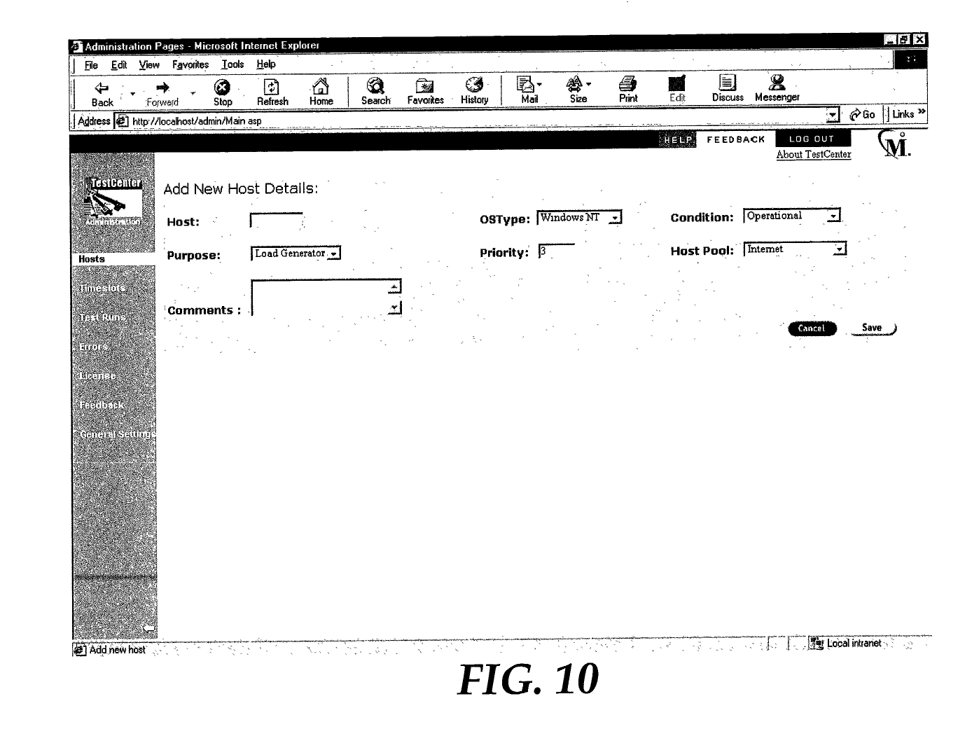

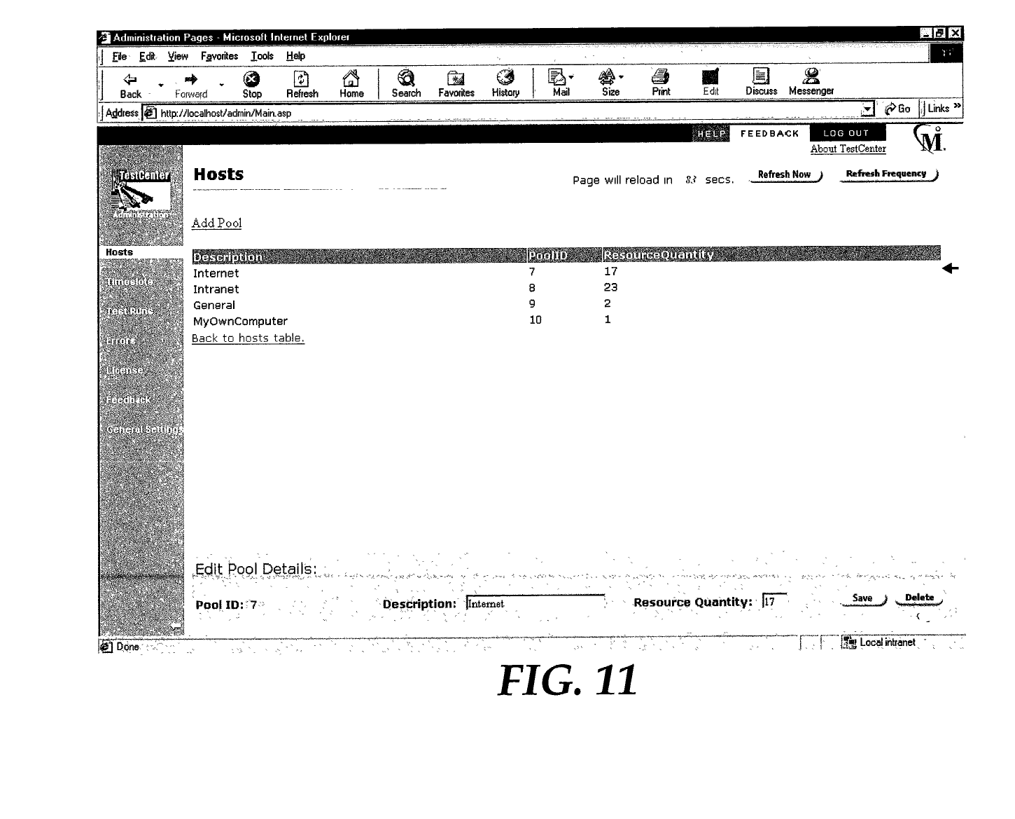

The Hosts page also includes respective buttons for adding a new host, editing pools, and detaching hosts from projects. Selection of the “add new host” button causes the Add New Host page (FIG. 10) to be displayed. Selection of the “edit resource pools” button causes the Pools page (FIG. 11) to be displayed. Selection of the “detach hosts” button causes a message to be displayed indicating that all hosts that are still attached to projects for which the timeslot period has ended (if any exist) will be detached, together which an option to either continue or cancel the operation.

FIG. 10 illustrates an Add New Host page that opens when that the “add new host” button is selected from the Hosts page. From the Add New Host page, a user may specify the host's name, operating system, condition, purpose, priority, and pool. The host priority values may, for example, be assigned according to performance such that machines with the greatest processing power are allocated first. In some embodiments, an hourly availability schedule may also be entered to indicate when the host may be used for load testing.

FIG. 11 illustrates the Pools page. As indicated above, pools may be defined for purposes of controlling which hosts are assigned to which projects. In a preferred embodiment, each host can be assigned to only a single pool at a time. Pools are assigned to projects in the preferred embodiment using the Privilege Manager pages, as discussed below in section V. As illustrated in FIG. 10, the Pools page lists the following information about each pool currently defined within the system: name, PoolID, and resource quantity (the maximum number of hosts from this pool that can be allocated to a timeslot). To add a new pool, the user may select the “add pool” link and then enter the name and resource quantity of the new pool (the PoolID is assigned automatically). To edit or delete a pool, the user selects the pool from the list, and then edit and save the pool details (or deletes the pool) using the “edit pool details” area at the bottom of the Pools page. As described below in subsection VII-C, a separate pool of controller hosts 104 may be defined in some embodiments.

FIG. 12 illustrates the Host Administration page for an example host. As indicated above, the Host Administration Page may be opened by selecting a host's status indicator from the Hosts page (FIG. 9). As illustrated, the Host Administration page displays information about the processes running on the host, and provides an option to terminate each such process.

C. Timeslot Reservation Pages

FIG. 13 illustrates one view of the Timeslots page of the Administration site 132. This page displays the following information for each timeslot reservation falling within the designated time window: the reservation ID (assigned automatically), the project name, the starting and stopping times, the host quantity (number of hosts reserved), and the host pool assigned to the project. A delete button next to each reservation allows the administrator to delete a reservation from the system. Using this page, an administrator can monitor the past and planned usage of host resources by the various users project teams. By selecting the link titled “switch to Hosts Availability Table,” the user can bring up another view “FIG. 14” which shows the number of hosts available within the selected pool during each one-hour timeslot.

D. Test Runs Page

FIG. 15 illustrates the Test Runs page of the admin site 132. This page displays information about ongoing and completed test runs, including the following: the ID and name of the test run; the project to which the test run belongs, the state of the test run, the number of Vusers that were running in the test (automatically updated upon completion), the ID of the relevant analysis host 124, if any; the analysis start, if relevant; and the date and time of the test run. The set of test runs displayed on the page can be controlled by adjusting the “time,” “state,” and “project” filters at the top of the page.

With further reference to FIG. 15, selection of a test run from the display causes the following additional information to be displayed about the selected test run: the test duration (if applicable); the maximum number of concurrent users; whether the object pointer or the collator pointer is pointing to a test run object in the repository 118 (if so, the user can reconnect the test); the name of the controller machine 120; the name(s) of the Vuser machine(s) 104; the location of the test results directory in the repository 118; and the number of Vusers injected during the test. Selection of the “change state” button causes a dialog box to be displayed with a list of possible states (not shown), allowing the administrator to manually change the state of the currently selected test run (e.g., if the run is “stuck” in a particular state). Selection of the “deallocate hosts” button causes a dialog to be displayed prompting the user to specify the type of host (load generator versus analysis host) to be deallocated or “detached” from a test run, and the ID of the test run.

E. Errors Page

FIG. 16 illustrates the Errors page of the admin site 132. This page allows administrators to monitor errors that occur during test runs. A “time” filter and a “severity” filter allow the administrator to control which errors are displayed. For each displayed error, the following information is displayed: the ID of the error; the time the error was recorded; the source of the error; the error's severity; the ID of the test run; and the host on which the error was found.

F. General Settings Page

FIG. 17 illustrates the General Settings page of the admin site 132. When the “use routing” feature is enabled via this page, a set of authorized target IP addresses may be specified, via the Privilege Manager 134, for each project. As discussed below in sections V and IX, any attempts to load test web sites or other systems 102 at other IP addresses are automatically blocked. The “routing” feature thus prevents or deters the use of the system's resources for malicious purposes, such as denial-of-service attacks on active web sites.

Another feature that may be enabled via the General Settings page is automatic host balancing. When this feature is enabled, the system 100 balances the load between hosts by preventing new Vusers from being launched on hosts that are fully utilized. The General Settings page can also be used to specify certain paths.

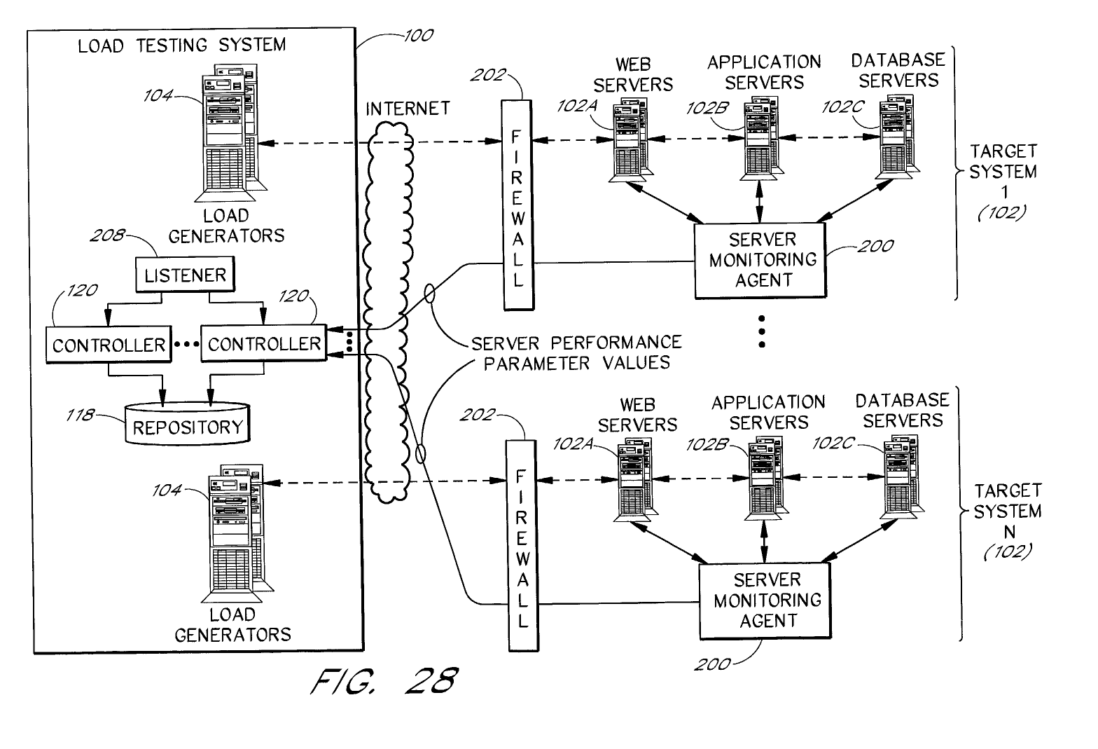

Yet another feature that may be enabled or configured from the General Settings page is a service for monitoring the servers of the target system 102 over a firewall of that system. Specifically an operator may specify the IP address of an optional “listener” machine that collects server monitor data from monitoring agents that reside locally to the target systems 102. This feature of the load testing system 100 is depicted in FIGS. 28-30 and is described in section X below.

V. Privilege Manager

The Privilege Manager 134 provides various functions for managing personal information, user information, project information, and privilege levels. Privilege levels define users' access rights within the Privilege Manager, and to the various other resources and functions of the system 100.

A. Navigation Menu and Privilege Levels

As illustrated in FIG. 18 and subsequent pages, the Privilege Manager pages include a navigation menu displayed on the left-hand side. The links displayed to a user within the navigation menu, and the associated actions that can be performed, depend upon the particular user's privilege level. In a preferred embodiment, three privilege levels are predefined within the system: guest, consultant, and administrator. As described below in subsection V-E, additional privilege levels can be defined within the system 100 using the User Privilege Configuration page.

The following summarizes the links that may be displayed in the navigation menu, and indicates the predefined classes of users (guest, consultant, and administrator) to which such links are displayed. For purposes of clarity in the following description, the term “viewer” will be used to refer to a user who is viewing the subject web page.

Personal Information—Opens a Personal Information page (FIG. 18), from which the viewer can view his or her own personal information and modify certain types of information. Displayed to: guests, consultants, administrators.

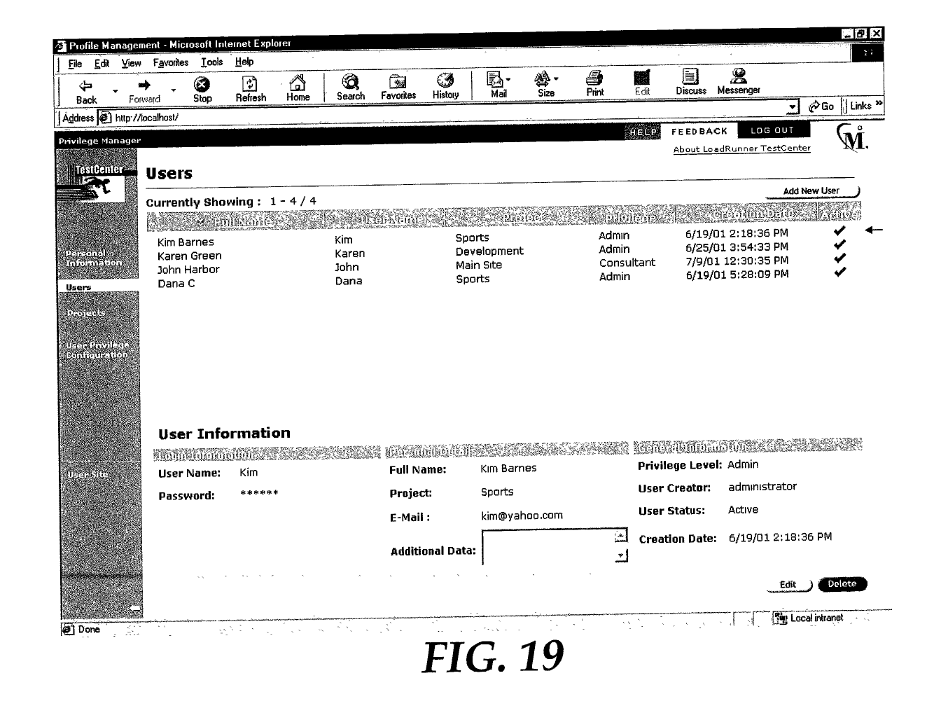

Users—Opens a Users page (FIG. 19), which displays and provides services for managing user information. From this page, the viewer can add and delete users, and can specify the projects each user may access. Displayed to: consultants, administrators.

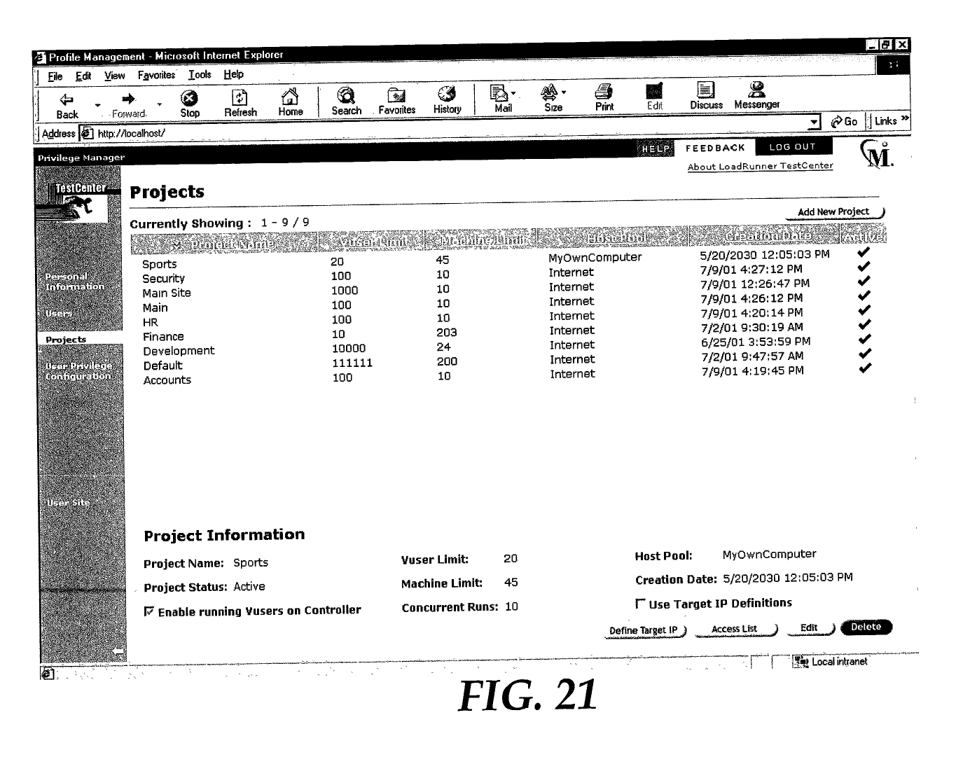

Projects—Opens a Projects page (FIG. 21), which displays and provides services for managing projects. Displayed to: administrators.

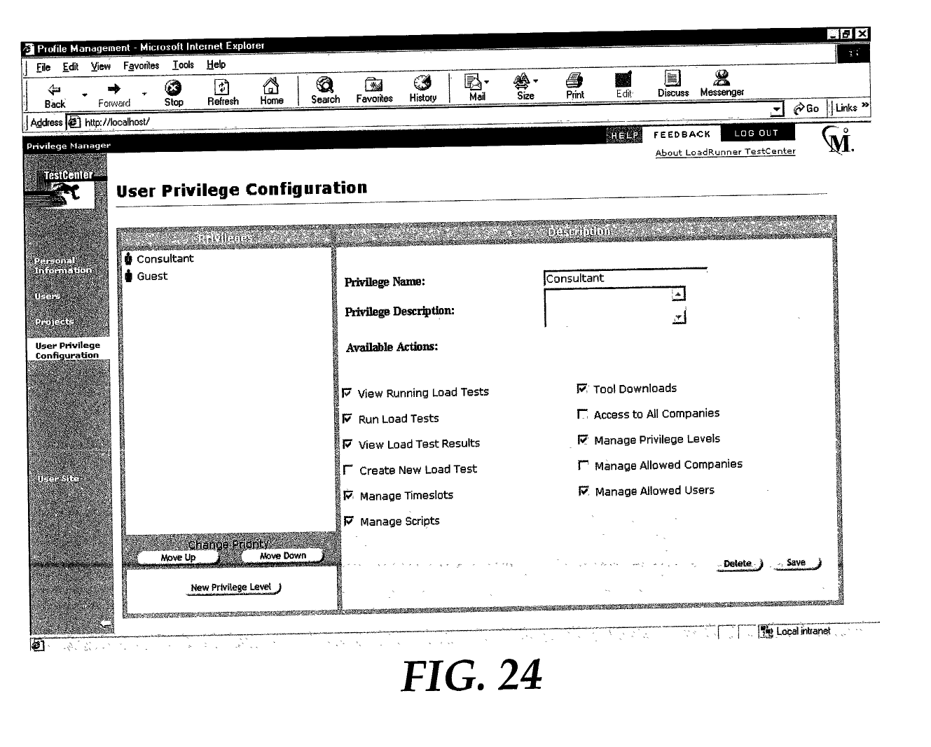

User Privilege Configuration—Opens a User Privilege Configuration page (FIG. 24), which provides services for managing and defining user privilege levels. Displayed to: administrators

As described below in section V, the actions that can be performed by users at each privilege level can preferably be specified via the Privilege Manager 134. For instance, “guests” may be given “view-only” access to load test resources (within designated projects), while “consultants” may additionally be permitted to create and run load tests and to manage the privilege levels of lower-level users. As further described below, each privilege level has a position in a hierarchy in the preferred embodiment. Users who can manage privilege levels preferably can only manage levels lower than their own in this hierarchy.

B. Personal Information Page

FIG. 18 illustrates the Personal Information page of the Privilege Manager 134. This page opens when a user enters the Privilege Manager 134, or when the Personal Information link is selected from the navigation menu. From this page, a user can view his or her own personal information, and can select an “edit” button to modify certain elements of this information. The following fields are displayed on the Personal Information page: username; password; full name; project (the primary or initial project to which the user is assigned); email address; additional data; privilege level; user creator (the name of the user who created this user profile in the system—cannot be edited); user status (active or inactive); and creation date (the date the profile was entered into the system).

C. Users Page

FIG. 19 illustrates the Users page of the Privilege Manager 134. This page is accessible to users whose respective privilege levels allow them to manage user information. This page displays a table of all users whose privilege levels are lower than the viewer's, except that administrators can view all users in the system. Selection of the “add new user” button causes a dialog box (not shown) to open from which the viewer can enter and then save a new user profile. Selection of a user from the table causes that user's information to be displayed in the “user information” box at the bottom of the page. Selection of the “edit button” allows certain fields of the selected user's information to be edited.

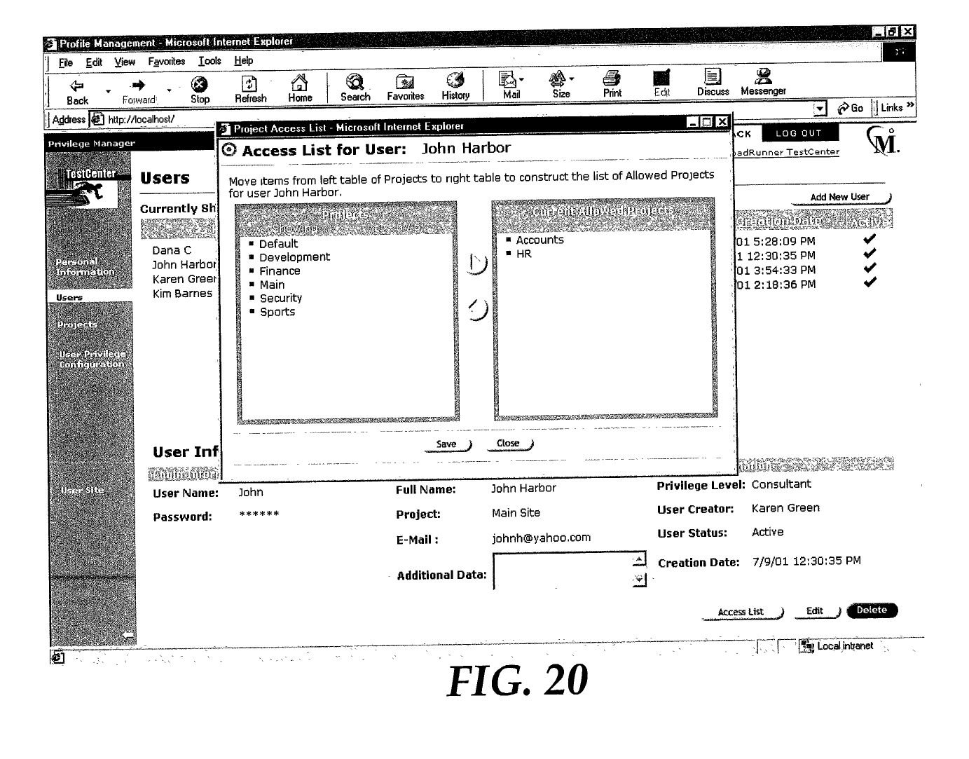

If the selected user's privilege level does not provide access rights to all projects, an “access list” button (FIG. 20) appears at the bottom of the Users page. As illustrated in FIG. 20, selection of the access list button causes a dialog box to open displaying a list of any additional projects, other than the one listed in the “user information” box, the selected user is permitted to access. If the viewer's privilege level permits management of users, the viewer may modify the displayed access list by adding or deleting projects.

D. Projects Page

FIG. 21 illustrates the Projects page of the Privilege Manager 134. This page displays a tabular listing of all projects the viewer is permitted to access (i.e., those included in the viewer's access list, or if the view is an administrator, all projects). The following properties are listed in the table for each project: project name, Vuser limit (the maximum number of Vusers a project can run at a time), machine limit (the maximum number of host machines a project can use at a time), the host pool assigned to the project, and the creation date, and whether the project is currently active. The total numbers of Vusers and machines used by all of the project's concurrent load tests are prevented from exceeding the Vuser limit and the machine limit, respectively. In the embodiment depicted by this Figure, only a single pool can be allocated to project; in other embodiments, multiple pools may concurrently be allocated to a project.

With further reference to FIG. 21, the “project information” box displays the following additional elements for the currently selected project: concurrent runs (the maximum number allowed for this project); a check box for enabling Vusers to run on a controller machine 120; and a check box for enabling target IP definitions (to restrict the load tests to certain targets, as discussed below). Selection of the “edit” button causes the “project information” box to switch to an edit mode, allowing the viewer to modify the properties of the currently selected project. Selection of the “delete” button causes the selected project to be deleted from the system.

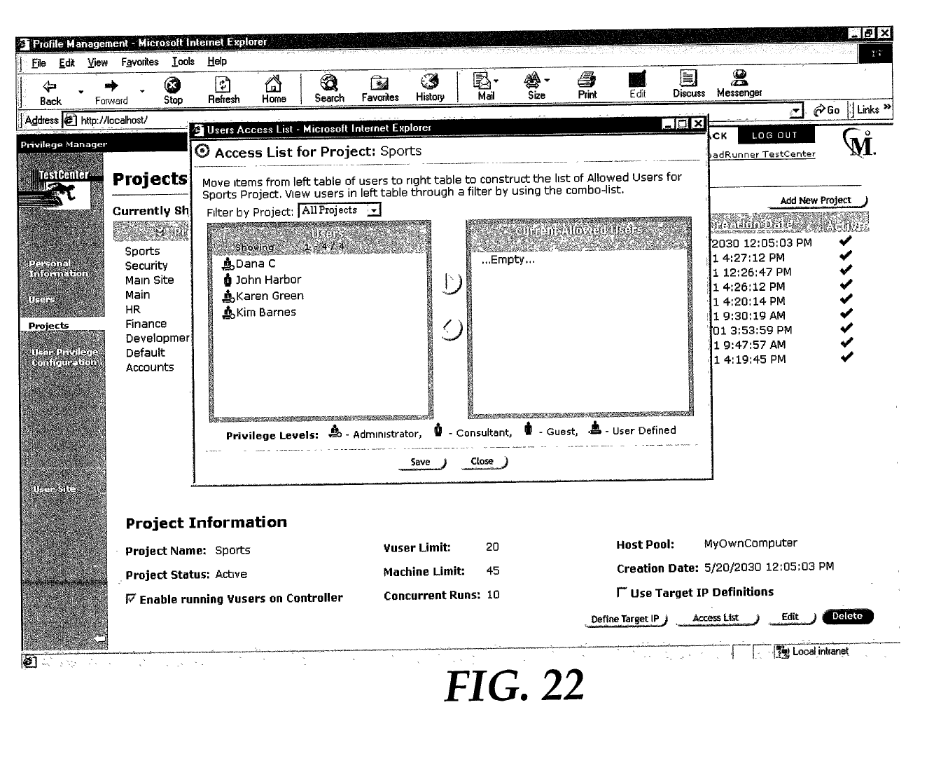

Selection of the “access list” button on the Projects page causes a project access list dialog box to open, as shown in FIG. 22. The pane on the right side of this box lists the users who have access rights to the selected project (referred to as “allowed users”), and who can thus access the User site 130 through this project. The pane on the left lists users who do not have access rights to the selected project; this list of includes users from all projects by default, and can be filtered using the “filter by project” drop down list. An icon beside each user's name indicates the user's privilege level. The two arrows between the frames allow the viewer to add users to the project, and remove users from the project, respectively.

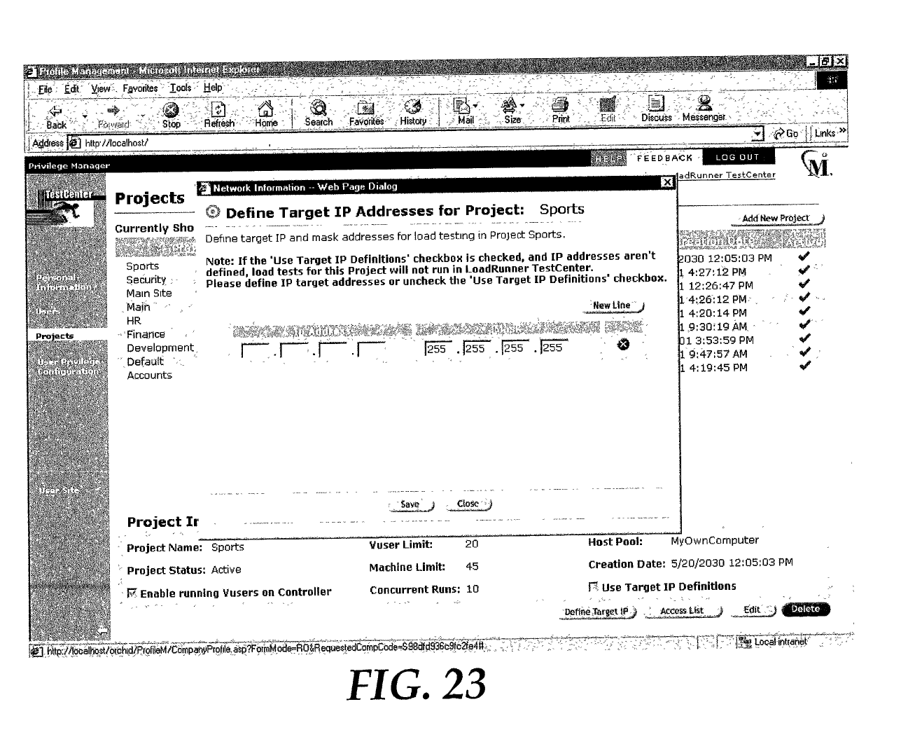

When the “use target IP definitions box” is checked for a project, target IP addresses must be defined in order for test runs to proceed within the project. If the box is not checked, the project may generally target its load tests to any IP addresses. Selection of the “define target IP” button on the projects page (FIGS. 21 and 22) causes a “define target IP addresses for project” dialog box to open, as shown in FIG. 23. Using this dialog box, the user can add, modify and delete authorized target IP addresses for the selected project.

To add a single IP address, the user enters the IP address together with the decimal mask value of 255.255.255.255 (which in binary form is 11111111 11111111 11111111 11111111). If the user wishes to authorize a range or group of IP addresses, the user enters an IP address together with a mask value in which a binary “0” indicates that the corresponding bit of the IP address should be ignored. For instance, the mask value 255.255.0.0 (binary 11111111 11111111 00000000 00000000) indicates that the last two octets of the IP address are to be ignored for blocking purposes. The ability to specify a mask value allows users to efficiently authorize testing of sites that use subnet addressing.

Various alternative methods and interfaces could be used to permit administrative users to designate authorized load testing targets. For instance, the user interface could support entry of target IP addresses on a user-by-user basis, and/or entry of target IP addresses for user groups other than projects. Further, the user interface may support entry of an exclusion list of IP addresses that cannot be targeted.

E. User Privilege Configuration Page

FIG. 24 illustrates the User Privilege Configuration page of the Privilege Manager 134. This page is accessible to users whose respective privilege levels allow them to manage privilege levels. Using this page, the viewer may edit privilege level definitions and add new privilege levels. The “privileges” pane on the left side of the page lists the privilege levels that fall below the viewer's own privilege level within the hierarchy; these are the privilege levels the viewer is permitted to manage. By adjusting the relative positions of the displayed privilege levels (using the “move up” and “move down” buttons), the viewer can modify the hierarchy.

Selection of a privilege level in the left pane causes that privilege level's definition to be displayed in the right pane, as shown for the privilege level “consultant” in the FIG. 24 example. The privilege level definition section includes a set of “available actions” check boxes for the actions the viewer can enable or disable for the selected privilege level. In the preferred embodiment, only those actions that can be performed by the viewer are included in this list. The available actions that may be displayed in the preferred embodiment are summarized in Table 3.

TABLE 3

| Available Action | Description |
|---|---|
| View Running Load Tests | Allows users to view their own projects' |
| | load tests in view-only mode, and is |
| | always checked |
| Run Load Tests | Allows users to run load tests, and to view |
| | test runs and perform certain operations |
| | during test runs, such as add Vusers and |
| | change test settings |
| View Load Test Results | Allows users to view the results of their |
| | own projects' load tests |
| Create New Load Test | Allows users to create and edit load tests |
| Manage Timeslots | Allows users to view timeslot availability |
| | and reserve, modify, and delete timeslots |
| Manage Scripts | Allows users to view, edit, upload and |
| | create Vuser scripts |
| Tool Downloads | Allows users to download applications |
| | from the downloads page of the User site |
| Access to all Projects | Allows access to all projects in the system |
| Manage Privilege Levels | Allows users to manage privilege levels |
| Manage Allowed Projects | Allows users to manage projects |
| Manage Allowed Users | Allows users to manage users |

New privilege levels can be added by selecting the “new privilege level” button, entering a corresponding definition in the right pane (including actions that may be performed), and then selecting the “save” button. The system thereby allows provides a high degree of flexibility in defining user access rights.

Typically, at least one privilege level (e.g., “guest”) is defined within the system 100 to provide view-only access to load tests.

VI. System Architecture

FIG. 25 illustrates the architecture of the system 100 according to one embodiment. In this implementation, the system includes one or more web server machines 122, each of which runs a web server process 122A and associated application code or logic 122B. The application logic 122B communicates with controllers 120 and analyzers 124 that may be implemented separately or in combination on host machines, including possibly the web server machines 122. The application logic also accesses a database 118A which stores various information associated with users, projects, and load tests defined within the system 100. Although not depicted in FIG. 25, a separate web server machine 122 may be used to provide the Administration site 132.

As depicted in FIG. 25, the application logic includes a Timeslot module, a Resource Management module, and an Activator module, all of which are preferably implemented as dynamic link libraries. The Timeslot and Resource Management modules are responsible for timeslot reservations and resource allocation, as described in section VII below. The Activator module is responsible for periodically checking the relevant tables of the database 118A to determine whether a scheduled test run should be started, and to activate the appropriate controller objects to activate new sessions. The Activator module may also monitor the database 118A to check for and report hanged sessions.

As illustrated in FIG. 25, each controller 120 includes the LoadRunner (LR) controller together with a wrapper. The wrapper includes an ActiveSession object which is responsible for driving the load testing session, via the LR controller, using LoadRunner™ Automation. The ActiveSession object is responsible for performing translation between the web UI and the LR controller, spreading Vusers among the hosts allocated to a session, and updating the database 118A with activity log and status data. The LR controller controls Vusers 104 (dispatches scripts and run time settings, etc.), and analyzes data from the Vusers to generate online graphs.

Each analyzer 124 comprises the LR analysis component together with a wrapper. The analyzers 124 access a file server 118B which stores Vuser scripts and load test results. The analyzer wrapper includes two objects, called AnalysisOperator and AnalysisManager, which run on the same host as the LR analysis component to support interactive analyses of test results data. The AnalysisOperator object is responsible, at the end of a session, for creating and storing on the file server 118B analysis data and a summary report for the session. These tasks may be performed by the machine used as the controller for the session. When interactive offline analysis is initiated by the user, the AnalysisOperator object copies the analysis data/summary report from the file server to a machine allocated for such analysis. The AnalysisManager object is a Visual Basic dynamic link library that provides additional interface functionality.

As depicted in FIG. 1 and discussed above, some or all of the components of the system 100 may reside within a testing lab on a LAN. In addition, some or all of the Vusers 104, and/or other components, may reside at remote locations 100B relative to the lab. More generally, the various components of the system 100 may be distributed on a WAN in any suitable configuration.

In the illustrated embodiment of FIG. 25, the controllers 120 communicate with the remote Vusers 104 through a firewall, and over a wide area network (WAN) such as the Internet. In other embodiments, separate controllers 120 may run at the remote location 100B to control the remote Vusers. The software components 104A, 120A, 124A (FIG. 1) for implementing the load generator, analyzer, and controller functions are preferably installed on all host computers to which a particular purpose may be assigned via the Administration site 132.

VII. Timeslot Reservations and Allocations of Hosts

As indicated above, the system 100 preferably manages timeslot reservations, and the allocation of hosts to test runs, using two modules: the Timeslot module and the Resource Management module (FIG. 25).

The Timeslot module is used to reserve timeslots within the system's timeslot schedule. The Timeslot module takes into account the start and end time of a requested timeslot reservation and the number of requested hosts (in accordance with the number of hosts the project's pool has in the database 118A). This information is compared with the information stored in the database 118A regarding other reservations for hosts of the requested pool at the requested time. If the requested number of machines are available for the requested time period, the timeslot reservation is added. The Timeslot module preferably does not take into consideration the host status at the time of the reservation, although host status is checked by the Resource Management module at the time of host allocation.

The Resource Management module allocates specific machines to specific test runs. Host allocation is performed at run time by verifying that the user has a valid timeslot reservation and then allocating the number of requested hosts to the test run. The allocation itself is determined by various parameters including the host's current status and priority.

As will be apparent, any of a variety of alternative methods may be used to allocate hosts without departing from the scope of the invention. For instance, rather that having users make reservations in advance of load testing, the users may be required or permitted to simply request use of host machines during load testing. In addition, where reservations are used, rather than allocating hosts at run time, specific hosts may be allocated when or shortly after the reservation is made. Further, in some embodiments, the processing power of a given host may be allocated to multiple concurrent test runs or analysis sessions such that the host is shared by multiple users at one time. The hosts may also be allocated without using host pools.

The following two subsections (A and B) describe example algorithms and data structures that may be used to implement the Timeslot and Resource Management modules. In this particular implementation, it is assumed that (1) only a single pool may be allocated to a project at a time, and that (2) a timeslot reservation is needed in order to run a test. Subsection C describes an enhancement which allows users to designate which machines are to be used, or are to be available for use, as controllers. Subsection D describes a further enhancement which allows users to select hosts according to their respective locations.

A. Timeslot Reservation Algorithm

Each timeslot reservation request from a user explicitly or implicitly specifies the following: start time, end time, number of machines required, project ID, and pool ID. In response to the request, the Timeslot module determines whether the following three conditions are met: (1) the number of machines does not exceed the maximum number of machines for the project; (2) the timeslot duration does not exceed the system limit (e.g., 24 hours); and (3) the project does not have an existing timeslot reservation within the time period of the requested timeslot (no overlapping is allowed). If these basic conditions are met, the Timeslot module further checks the availability of the requested timeslot in comparison to other timeslot reservations during the same period of time, and makes sure that there are enough machines in the project pool to reserve the timeslot. Table 4 includes a pseudocode representation of this process.

TABLE 4
Timeslot Reservations

Reserve(ProjectID, FromTime, ToTime, MachineRequired, PoolID)
{

canReserve = CheckIfCanReserve(ProjectID, FromTime,
ToTime, MachineRequired, PoolID)

If(canReserve = True)

Reserve a new timeslot

Else

Return “Cannot reserve a timeslot”

}
CheckIfCanReserve(ProjectID, FromTime, ToTime, MachineRequired,
PoolID)
{

//Check user's project limit
If (GetProjectMachineLimit(ProjectID) < MachineRequired)

Return “Cannot reserve a timeslot”

//Check timeslot duration—the duration can't exceed 24 hours
If (ToTime-FromTime > TIMESLOT_DURATION)

Return “Cannot reserve a timeslot”

//Check if exist overlap
If (ExistOverlap( ))

Return “Cannot reserve a timeslot”

CheckAvailability(FromTime, ToTime, MachineRequired, PoolID)

}
CheckAvailability(FromTime, ToTime, MachineRequired, PoolID)
{

//GetRelevantTimeslotsInvolved
timeslotRecordes =SELECT all timeslot from TimeslotTable
WHERE FromTime <= Requested ToTime and ToTime >
Requested FromTime and PoolID=UserPoolID order by time
asc
//Split each timeslot to 2 different records
timeslotSplittedRecords = for each record in timeslotRecords

createFromTimeRecord
createToTimeRecord

//check availability
For each record in timeslotSplittedRecords do

CurrentMachineQuantity = GetCurrentRecordQuantity( )
CurrentState = GetCurrentRecordState( )
If (CurrentState = START)

QuantityOccupied += CurrentMachineQuantity

If (CurrentState = END)

QuantityOccupied −= CurrentMachineQuantity

If (QuantityOccupied > (globalResourceQuantity -
MachineRequired))

Return “Cannot reserve a timeslot”

End for
Return “Can Reserve a timeslot”

}

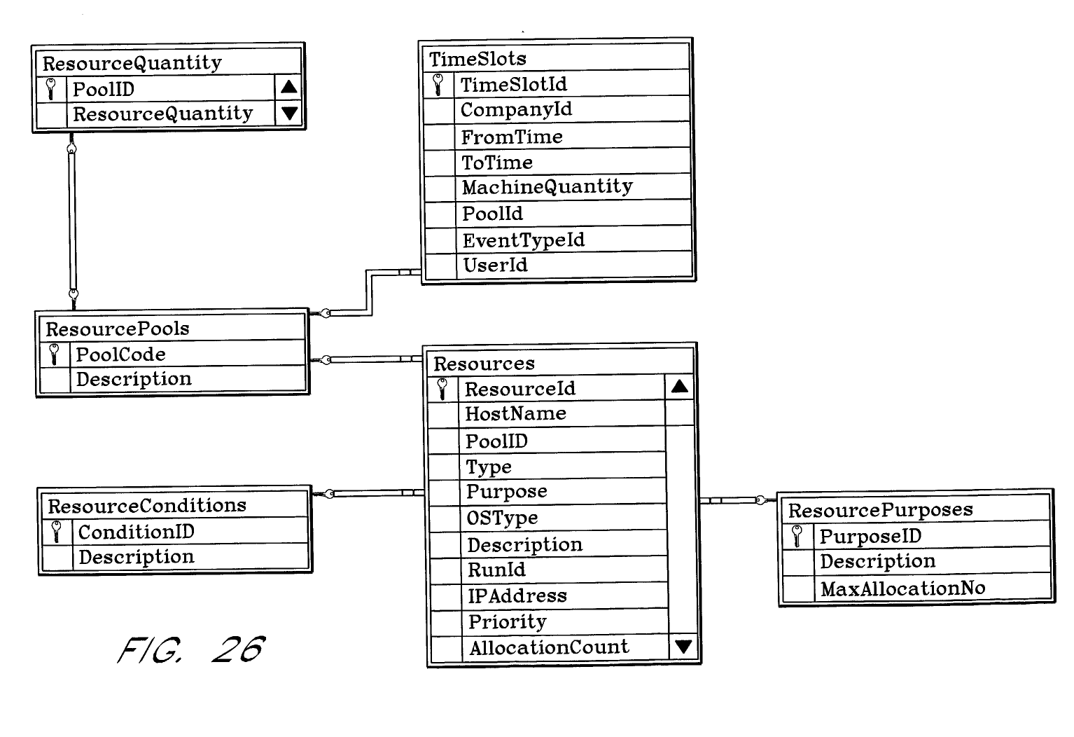

FIG. 26 illustrates an associated database design. The following is a summary of the tables of the database:

Resource Quantity—Stores the number of machines of each pool. An enhancement for distinguishing the controller and load-generator machines is to specify the number of machines of each purpose of each pool.

Timeslots—Stores all the timeslots that were reserved, along with the number of machines from each pool. An enhancement for allowing the selection of machines from a specific location is to store the number of machines from each pool at each location.

Resources—Stores the information on the machines (hosts) of the system 100, along with the attributes, purpose, and current status of each machine. An enhancement for allowing the selection of machines from specific locations is to store the location of the host as well.

ResourcePools—Stores the id and description of each machine pool.

ResourcePurposes—Stores the id and description of each machine purpose, and the maximum number of concurrent sessions that can occur on a single machine (e.g. one implementation may be to allow 5 concurrent analysis sessions on the same machine).

ResourceCondistions—Stores the id and description of each condition.

B. Host Allocation Algorithm

At run time, the Resource Management module initially confirms that the user initiating the test run has a valid timeslot reservation. While running the test, the Resource Management module allocates hosts to the test run as “load generators” by searching for hosts having the following properties (see Table 2 above for descriptions of these property types):

Run ID: “null”

Allocation: “0” (i.e., not currently allocated to any test run)

Condition: “operational”

Purpose: “load generator” (as opposed to “analysis”)

Pool: the same pool as specified for the project for whom the test is being run. Each project is allowed to be assigned hosts from a specific pool. This pool is specified in the project information page.

Project: either “none” or the name of the project for whom the test is being run. Priority goes to hosts already assigned to the project.

In some embodiments, the algorithm may permit a host having a non-zero allocation value to be allocated to a new test run, so that a host may be allocated to multiple test runs concurrently.

If the number of host machines satisfying these requirements exceeds the number reserved, the machines are selected in order of highest to lowest priority level. Of the selected load generator hosts, one is used as the test run's controller (either in addition to or instead of a true load generator, depending upon configuration), and the others are used as true load generators or “injectors.”

When an interactive analysis of the load test data is requested, the Resource Management module allocates a host to be used as an analyzer 124 by selecting a host having the following properties:

Condition: “operational”

Purpose: “analysis”

Allocation: “0-4x” (i.e., one host can be used for the interactive analysis of up to x test runs simultaneously, where the value of “x” is configurable by the administrator of the system 100)

In some embodiments, the Resource Management module may initially verify that the user has a valid timeslot reservation before allocating a host to an interactive analysis session.

C. Designation of Controller Hosts

One enhancement to the design described above is to allow users to designate, through the Administration site 132, which hosts may be used as controller hosts 120. The task of assigning a controller “purpose” to hosts is preferably accomplished using one or both of two methods: (1) defining a special pool of controller machines (in addition to the project pools); (2) designating machines within the project pool that may function as controllers.

With the “controller pool” method (#1 above), a user of the Administration site 132 can define a special pool of “controller-only” hosts that may not be used as load generators 104. The hosts 120 in this controller pool may be shared between the various projects in the system 100, although preferably only one project may use such a host at a time. When a timeslot is reserved for a test, the Timeslot module determines whether any hosts are available in the controller pool, in addition to checking the availability of load generators 104, as described in subsections VII-A and VII-B above. If the necessary resources are available, the Resource Management module automatically allocates one of the machines from the controller pool to be the controller machine for the load test, and allocates load generator machines to the test run from the relevant project pool. Table 5 illustrates a pseudocode representation of this method.

TABLE 5
Resource Allocation Using Controller Pool

Reserve (ProjectID, RequestedFromTime, ToTime, MachineRequired,
PoolID)
{

BEGIN TRANSACTION

//Check availability for the controller machine
CheckAvailability (FromTime, ToTime,
MachineRequired, Controllers_pool)
//Check availability for the load generator machines
CheckAvailability (FromTime, ToTime,
MachineRequired, PoolID)

COMMIT TRANSACTION

Reserve a timeslot

ROLLBACK TRANSACTION

Return “Can't reserve a timeslot”

}

With method #2 (designating machines within the project pool to function as controllers), machines may be dynamically allocated from a project pool to serve as the controller host 104 for a given test run—either exclusively or in addition to being a load generator. With this method, there is no sharing of controller hosts between pools, although there may be sharing between projects since one pool may serve many projects. In a preferred embodiment, administrators may assign one of four “purposes” to each host: analysis (A); load generator (L); controller (C); or load generator+controller (L+C). For a timeslot reservation request to be successful, the following three conditions preferably must be met: (1) the number of timeslots currently reserved [symbol] C+(C+L), meaning that there are enough controllers in the system; (2) the number of requested load generators for the timeslot [symbol] L+(C+L), meaning that there are enough load generators in the system; and (3) the number of timeslots currently reserved+the number of requested load generators for the timeslot [symbol] L+(C+L)+C.

In practice, the system 100 may use both methods described above for allocating resources. For example, the system may initially check for controllers in the controller pool (if such pool exists), and allocate a controller machine to the test if one is available. If no controller machines are available in the controller pool, the system may continue to search for a controller machine from the project's pool, with machines designated exclusively as controllers being given priority over those designated as controllers+load generators. Once a controller has been allocated to the test run, the resource allocation process may continue as described in subsection VII-B above, but preferably with hosts designated exclusively as load generators being given priority over hosts designated as controllers+load generators.

D. Reserving Machines in Specific Locations

Another enhancement is to allow testers to reserve hosts, via the User site 130, in specific locations. For instance, as depicted in FIG. 27, the user may be prompted to specify the number of injector (load generator) hosts to be used in each of the server farm locations that are available, each of which may be in a different city, state, country, or other geographic region. The user may also be permitted to select the controller location. In such embodiments, the algorithm for reserving timeslots takes into consideration the location of the resource in addition to the other parameters discussed in the previous subsections. Table 6 illustrates an example algorithm for making such location-specific reservations.

TABLE 6
Location-Specific Resource Reservations

BEGIN TRANSACTION

//Check availability for machines in location A
CheckAvailability (FromTime, ToTime, MachineRequired,
Location_A)
//Check availability for machines in location B
CheckAvailability (FromTime, ToTime, MachineRequired,
Location_B)
. . .

COMMIT TRANSACTION

Reserve a timeslot

ROLLBACK TRANSACTION

Return “Can't reserve a timeslot”

Another option is to allow the user to designate the specific machines to be reserved for load testing, rather than just the number of machines. For example, the user may be permitted to view a list of the available hosts in each location, and to select the specific hosts to reserve from this list.

As mentioned above, users could also be permitted to make reservations by specifying the number of Vusers needed, the expected maximum load, or some other unit of processing capacity. The system 100 could then apply an algorithm to predict or determine the number of hosts needed, and reserve this number of hosts.

VIII. Resource Sharing and Negotiation Between Installations

One feature that may be incorporated into the system design is the ability for resources to be shared between different installations of the system 100. Preferably, this feature is implemented using a background negotiation protocol in which one installation of the system 100 may request use of processing resources of another installation. The negotiation protocol may be implemented within the application logic 122B (FIG. 25) or any other suitable component of the load testing system 100. The following example illustrates how this feature may be used in one embodiment.

Assume that a particular company or organization has two different installations of the load testing system—TC1 and TC2. The load generators of TC1 are located at two locations—DI and GTS, while the load generators of TC2 are located at the location AT&T. A user of TC1 has all the data relevant to his/her project in the database 118 of TC1. He/she also usually uses the resources of TC1 in his/her load-tests. Using the UI for selecting locations (see FIG. 27), this user may also request resources of TC2. For example, the user may specify that one host in the location AT&T is to be used as a load generator, and that another AT&T host is to be used as the controller. The user may make this request without knowing that the location AT&T is actually part of a different farm or installation.

In response to this selection by the user, TC1 generates a background request to TC2 requesting use of these resources. TC2 either confirms or rejects the request according to its availability and its internal policy for lending resources to other farms or installations. If the request is rejected, a message may be displayed indicating that the requested resources are unavailable. Once the resources are reserved, the reservation details are stored in the repositories 118 of both TC1 and TC2. When running the test, TC1 requests specific machines from TC2, and upon obtaining authorization from TC2, communicates with these machines directly. All the data of the test run is stored in the repository 118 of TC1.

IX. Protection Against Potentially Harmful Scripts

Two forms of security are preferably embodied within the system 100 to protect against potentially harmful scripts. The first is the above-described routing feature, in which valid target IP addresses may be specified separately for each project. When this feature is enabled, the routing tables of the load generator hosts 104 are updated with the valid target IP addresses when these hosts are allocated to a test run. This prevents the load generator hosts 104 from communicating with unauthorized targets throughout the course of the test run.

The second security feature provides protection against scripts that may potentially damage the machines of the load testing system 100 itself. This feature is preferably implemented by configuring the script interpreter module (not shown) of each Vuser component 104A to execute only a set of “allowed” functions. As a Vuser script is executed, the script interpreter checks each line of the script. If the line does not correspond to an allowed function, the line is skipped and an error message is returned. Execution of potentially damaging functions is thereby avoided.

X. Server Monitoring over Firewall

Another important feature that may be incorporated into the load testing system 100 is an ability to remotely monitor the machines and components of the target system 102 over a firewall during load testing. FIG. 28 illustrates one embodiment of this feature. Dashed lines in FIG. 28 represent communications resulting from the load test itself, and solid lines represent communications resulting from server-side monitoring.

As illustrated, a server monitoring agent component 200 is installed locally to each target system 102 to monitor machines of that system. The server monitoring agent 200 is preferably installed on a separate machine from those of the target system 102, inside the firewall 202 of the target system. In the example shown, each server monitoring agent 200 monitors the physical web servers 102A, application servers 102B, and database servers 102C of the corresponding target system 102. The server monitoring agent 200 may also monitor other components, such as the firewalls 202, load balancers, and routers of the target system 102. The specific types of components monitored, and the specific performance parameters monitored, generally depend upon the nature and configuration of the particular target system 102 being load tested. Typically, the server monitoring agents 200 monitor various server resource parameters, such as “CPU utilization” and “current number of connections,” that may potentially reveal sources or causes of performance degradations. The various server resource parameters are monitored using standard application program interfaces (APIs) of the operating systems and other software components running on the monitored machines.

As further depicted in FIG. 28, during load test execution, the server monitoring agent 200 reports parameter values (measurements) to a listener component 208 of the load testing system 100. These communications pass through the relevant firewall 202 of the target system 102. The listener 208, which may run on a dedicated or other machine of the load testing system 100, reports these measurement values to the controller 120 associated with the load test run. The controller 120 in turn stores this data, together with associated measurement time stamps, in the repository 118 for subsequent analysis. This data may later be analyzed to identify correlations between overall performance and specific server resource parameters. For example, using the interactive analysis features of the system 100, an operator may determine that server response times degrade significantly when the available memory space in a particular machine falls below a certain threshold.

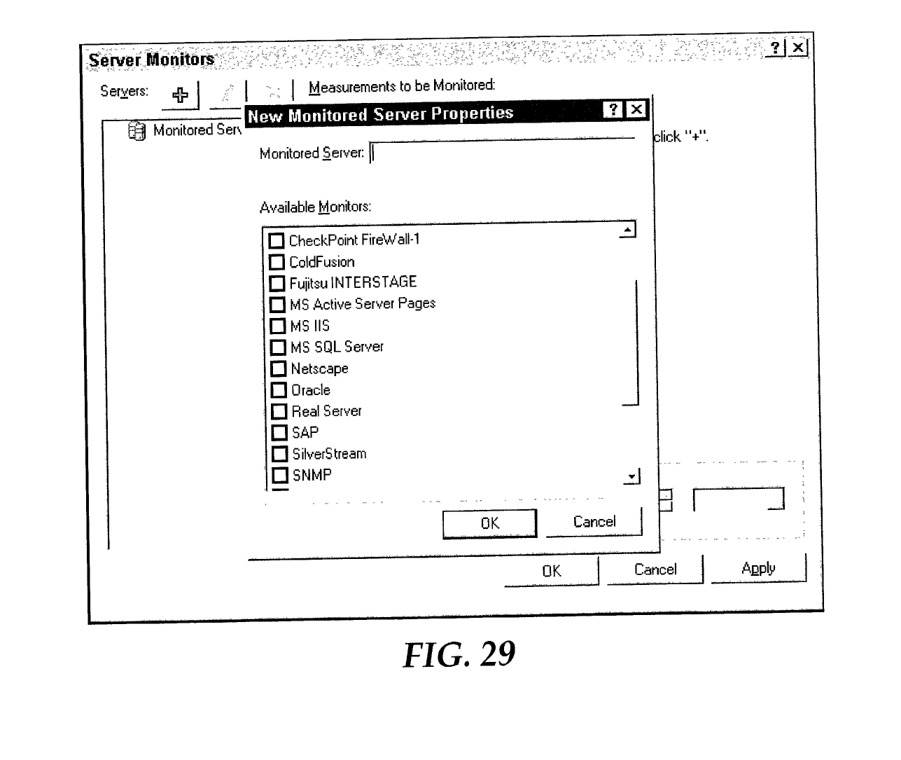

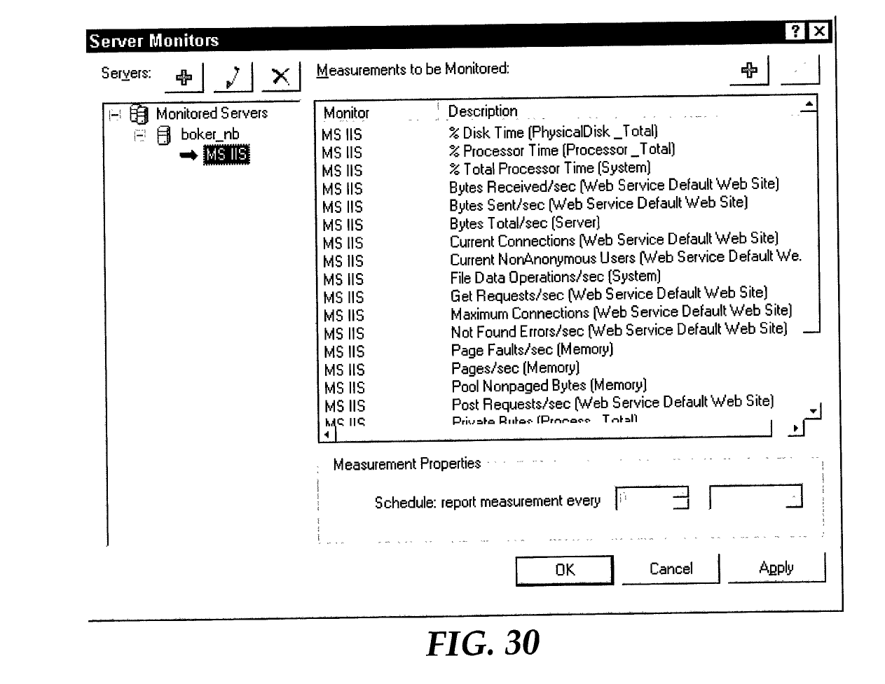

The server monitoring agent component 200 preferably includes a user interface through which an operator or tester of the target system 102 may specify the machines/components to be monitored and the parameters to be measured. Example screen displays of this user interface are shown in FIGS. 29 and 30. As illustrated in FIG. 29, the operator may select a machine (server) to be monitored, and specify the monitors available on that machine. As depicted in FIG. 30, the operator may also specify, on a server-by-server basis, the specific parameters to be monitored, and the frequency with which the parameter measurements are to be reported to the listener. The UI depicted in FIGS. 29 and 30 may optionally be incorporated into the User site 130 or the Administration site 132, so that the server monitoring agents 200 may be configured remotely by authorized users.

XI. Hosted Service Implementations

The foregoing examples have focussed primarily on implementations in which the load testing system 100 is set up and used internally by a particular company for purposes of conducting and managing its own load testing projects. As mentioned above, the system 100 may also be set up by a third party load testing “service provider” as a hosted service.

In such “hosted service” implementations, the service provider typically owns the host machines, and uses the Administration site 132 to manage these machines. As part of this process, the service provider may allocate specific pools of hosts to specific companies (customers) by simply allocating the pools to the customers' projects. The service provider may also assign an appropriately high privilege level to a user within each such company to allow each company to manage its own respective projects (manage users, manage privilege levels and access rights, etc.) via the Privilege Manager 134. Each customer may then manage and run its own load testing projects securely via the User site 130 and the Privilege Manager 134, concurrently with other customers.

Each customer may be charged for using the system 100 based on the number of hosts allocated to the customer, the amount of time of the allocations, the durations and host quantities of timeslot reservations, the number of Vusers used, the throughput, the number of test runs performed, the time durations and numbers of hosts allocated to such test runs, the number of transactions executed, and/or any other appropriate usage metric. Activity data reflecting these and other usage metrics may be recorded in the database 118A by system components.

Various hybrid architectures are also possible. For example, a company may be permitted to rent or otherwise pay for the use of load generator hosts operated by a testing service provider, while using the company's own machines to run other components of the system.

XII. Conclusion

The illustrative embodiments described above provide numerous benefits over conventional testing systems and methods. These benefits include more efficient sharing of test data and test results across multiple locations, more efficient use of processing resources (e.g., because multiple groups of users can efficiently share the same hosts without being exposed to each other's confidential information), increased ability to use remote testing consultants/experts and reduced travel expenses for such use, and improved efficiency in managing and completing testing projects.

Although the invention has been described in terms of certain preferred embodiments, other embodiments that are apparent to those of ordinary skill in the art, including embodiments which do not provide all of the features and advantages set forth herein, are also within the scope of this invention as defined by the appended claims.

What is claimed is:

1. A network-based load testing system, comprising:
a multi-user load testing application which runs in association with a plurality of host computers connected to a network, the multi-user load testing application providing functionality for specifying, running, and analyzing results of a load test in which a load is applied by one or more of the host computers over a wide area network to a target system while monitoring responses of the target system; and
a data repository component that stores data associated with the load tests;
wherein the multi-user load testing application includes a web-based user interface through which users may specify, run, and analyze results of the load tests remotely using a web browser.

2. The network-based load testing system as in claim 1, wherein the load testing application provides functionality for users to reserve host processing resources of the plurality of host computers for specified time periods for conducting load testing.

3. The network-based load testing system as in claim 2, wherein a user reserves host processing resources by at least specifying, via the web-based user interface, a desired number of host computers and a desired time slot.

4. The network-based load testing system as in claim 2, wherein the load testing application facilitates creation of a reservation of host processing resources by displaying to a user resource availability information reflective of reservations made by other users of the system.

5. The network-based load testing system as in claim 2, wherein the load testing application provides functionality for an administrative user to view and cancel reservations of host processing resources made by other users.

6. The network-based load testing system as in claim 1, wherein the web-based user interface permits a user to designate locations of host computers to be reserved, whereby a user may specify multiple host locations from which a load is to be generated during a load test run.

7. The network-based load testing system as in claim 1, wherein the load testing application provides functionality for allocating the host computers to load tests such that multiple load tests may be run concurrently by different users of the system.

8. The network-based load testing system as in claim 7, wherein the load testing application allocates host computers to load test runs based at least in-part on pre-specified priority levels assigned to the host computers.

9. The network-based load testing system as in claim 1, wherein the load testing application provides functionality for defining and assigning users to load testing projects, wherein membership to a load testing project confers access rights to data associated with that project stored by the data repository component such that project members may collaborate on load testing projects.

10. The network-based load testing system as in claim 9, wherein the load testing application provides functionality for an administrative user to define pools of the host computers, and to allocate a pool of the host computers to a load testing project.

11. The network-based load testing system as in claim 1, wherein the load testing application is configured to block attempts by users to load test unauthorized target systems.

12. The network-based load testing system as in claim 1, wherein the web-based user interface provides functionality for an administrative user to separately specify, for each of a plurality of sets of users, a set of target IP addresses that may be load tested by that set of users.

13. The network-based load testing system as in claim 1, wherein the web-based user interface includes a user web site and an administration web site, wherein the user web site provides functionality for testers to remotely specify, run and analyze results of load tests, and the administration site provides functionality for administrators to remotely manage and monitor the host computers.

14. The network-based load testing system as in claim 13, wherein the administration web site includes functions for adding new host computers to the system, and for configuring and monitoring the operation of the host computers.

15. The network-based load testing system as in claim 13, wherein the administration web site includes functions for assigning at least one of the following purposes to a host computer to control how that host computer may be used: load generator, load test controller, load test results analyzer.

16. The network-based load testing system as in claim 13, wherein the administration web site includes functions for defining pools of the host computers, and for allocating the pools to specific groups of users.

17. The network-based load testing system as in claim 1, further comprising a server monitoring component adapted to run locally to the target system during load testing to monitor and report server performance parameters of the target system.

18. A multi-user load testing application, comprising:
a user interface component that provides functions for users to remotely define, run, and analyze results of load tests, wherein the user interface component is adapted to run in association with a plurality of host computers that are configured to operate as load generators during load test runs;
a data repository component that stores data associated with the load tests; and
a resource allocation component that allocates the host computers such that multiple users may run load tests concurrently using the plurality of host computers.

19. The multi-user load testing application as in claim 18, wherein the user interface component includes a collection of web pages through which users may remotely define, run, and analyze results of load tests using a web browser.

20. The multi-user load testing application as in claim 18, wherein the user interface component provides functionality for users to reserve host processing resources for conducting load testing.

21. The multi-user load testing application as in claim 20, wherein the user interface component prompts a user to specify a number of host computers and a time slot for reserving host processing resources.

22. The multi-user load testing application as in claim 21, wherein the user interface component further permits a user to designate locations host computers to be reserved.

23. The multi-user load testing application as in claim 20, wherein the user interface component facilitates creation of a reservation of host processing resources by displaying to a user host resource availability information reflective of reservations made by other users of the system.

24. The multi-user load testing application as in claim 20, wherein the user interface component provides functionality for an administrative user to view and cancel reservations of host processing resources made by other users.

25. The multi-user load testing application as in claim 18, wherein the user interface component provides functionality for defining and assigning users to load testing projects, wherein membership to a load testing project confers access rights to data associated with that project stored by the data repository component.

26. The multi-user load testing application as in claim 25, wherein the user interface component provides functionality for an administrative user to define pools of the host computers, and to allocate a pool of the host computers to a load testing project.

27. The multi-user load testing application as in claim 18, wherein the resource allocation component allocates host computers to load test runs based at least in-part on pre-specified priority levels assigned to the host computers.

28. The multi-user load testing application as in claim 18, further comprising a component configured to block attempts by users to load test unauthorized target systems.

29. The multi-user load testing application as in claim 18, wherein the user interface component provides functionality for an administrative user to separately specify, for each of a plurality of sets of users, a set of target IP addresses that may be load tested by that set of users.

30. The multi-user load testing application as in claim 18, wherein the user interface component includes a user web site and an administration web site, wherein the user web site provides functionality for testers to remotely specify, run and analyze results of load tests, and the administration site provides functionality for administrators to remotely manage and monitor the host computers.

31. The multi-user load testing application as in claim 30, wherein the administration web site includes functions for adding new host computers to the system, and for configuring and monitoring the operation of the host computers.

32. The multi-user load testing application as in claim 30, wherein the administration web site includes functions for defining pools of the host computers, and for allocating the pools to specific groups of users.

33. A system for conducting load tests using shared processing resources, comprising:
a plurality of host computers coupled to a computer network and having load testing software installed thereon, at least some of the plurality of host computers being configured to operate as load generators for applying a load to a target system over a wide area network;
a scheduling user interface through which a user may reserve host processing resources of the host computers for a desired time period for conducting load testing;
a database that stores reservations of host processing resources created by users with the scheduling user interface; and
a resource allocation component that allocates host computers to load tests in accordance with the reservations stored in the database such that multiple load tests may be run from the plurality of host computers concurrently by different respective users of the system.

34. The system as in claim 33, wherein the resource allocation component allocates host computers to load tests based at least in-part on pre-specified priority levels assigned to the host computers.

35. The system as in claim 33, wherein the resource allocation component allocates host computers to load tests based at least in-part on statuses of the host computers at run time.

36. The system as in claim 33, wherein the resource allocation component provides functionality for an administrative user to define multiple pools of host computers, and to allocate each such pool to a different set of users.

37. The system as in claim 33, wherein the resource allocation component allocates host computers to a load test run at run time.

38. The system as in claim 33, wherein the scheduling user interface prompts the user to specify a number of host computers to be reserved.

39. The system as in claim 33, wherein the scheduling user interface permits a user to reserve host computers by location.

40. The system as in claim 33, wherein the scheduling user interface facilitates creation of a reservation by displaying to the user host availability information reflective of reservations made by other users of the system.

41. The system as in claim 33, further comprising a web-based user interface that provides functionality for users to specify, run, and analyze the results of the load tests remotely using a web browser.

42. A networked computer system for conducting tests of target systems, comprising:
a plurality of host computers coupled to a computer network;
a multi-user testing application that runs in association with the plurality of host computers and provides functionality for users to define, run and analyze results of tests in which the host computers are used to access and monitor responses of target systems over a computer network; and
a data repository that stores test data associated with the tests, the test data including definitions and results of the tests;
wherein the multi-user testing application provides functionality for defining projects and assigning users to such projects such that membership to a project confers access rights to the test data associated with that project, the multi-user testing application thereby facilitating collaboration between project members.

43. The networked computer system as in claim 42, wherein the multi-user testing application is a web-based application that enables users to define, run and analyze results of tests remotely using a web browser.

44. The networked computer system as in claim 43, wherein the multi-user testing application includes a user web site and an administration web site, wherein the user web site provides functionality for testers to remotely specify, run and analyze tests, and the administration site provides functionality for administrators to remotely manage and monitor the host computers.

45. The networked computer system as in claim 42, wherein the multi-user testing application provides functionality for an administrative user to define pools of the host computers, and to allocate the pools to specific projects.

46. The networked computer system as in claim 42, wherein the multi-user testing application provides functionality for an administrative user to separately specify, for each project, a set of authorized target IP addresses for that project, wherein attempts to test target systems at unauthorized target IP addresses are automatically blocked.

47. The networked computer system as in claim 42, wherein the multi-user testing application provides functionality for users to reserve desired quantities of the host computers for desired time periods to conduct load tests.

48. The networked computer system as in claim 42, wherein the multi-user testing application automatically allocates host computers to test runs.

49. The networked computer system as in claim 42, wherein the multi-user testing application is capable of running multiple load tests concurrently.

50. A network-based load testing system, comprising:
a plurality of host computers connected to a computer network and having load testing software stored thereon;
a user component that provides functionality for users to remotely define and run load tests in which loads are applied to target systems over a wide area network by sets of the host computers while monitoring responses of the target systems; and
an administrative component that provides functionality for an administrative user to remotely manage and monitor usage of the plurality of host computers.

51. The network-based load testing system as in claim 50, wherein the administrative component provides functionality for an administrative user to define multiple pools of the host computers, and to assign the pools to user groups to allocate load testing processing resources to such user groups.

52. The network-based load testing system as in claim 50, wherein the administrative component provides functionality for an administrative user to make individual host computers of the plurality available and unavailable for conducting load tests.

53. The network-based load testing system as in claim 50, wherein the administrative component includes functions for assigning at least one of the following purposes to a host computer to control how that host computer may be used: load generator, load test controller, load test results analyzer.

54. The network-based load testing system as in claim 50, wherein the user component includes a scheduling interface through which users create reservations of host processing resources for conducting load tests, and wherein the administrative component allows an administrative user to view and cancel such reservations.

55. A multi-user load testing application, comprising:
a first component that provides functions for users to remotely define and run load tests in which loads are applied to target systems over a wide area network by a set of host computers;
a second component that provides functionality for an administrative user to specify authorized target IP addresses for conducting the load tests; and
a third component that automatically blocks attempts by users to conduct load tests of target systems at unauthorized target IP addresses;
whereby protection is provided against use of the host computers to conduct denial-of-service attacks against target systems.

56. The multi-user load testing application as in claim 55, wherein the second component provides functionality for separately specifying authorized target IP addresses for each of a plurality of users groups.

57. The multi-user load testing application as in claim 56, wherein each of the user groups corresponds to a respective load testing project defined within a database.

58. The multi-user load testing application as in claim 55, wherein the second component accepts entry of authorized target IP addresses in the form of a target IP address and a corresponding mask address.

59. The multi-user load testing application as in claim 55, wherein the first component includes a web-based user interface through which users may create and run load tests remotely using web browsers.
